(19) United States
(12) Patent Application Publication
(10) Pub. No.: US 2026/0289261 A1
(43) Pub. Date: Sep. 24, 2026

(54) SYSTEM

(71) Applicant: SoftBank Group Corp., Tokyo (JP)

(72) Inventor: Teruaki OIYAMA, Tokyo (JP)

(73) Assignee: SoftBank Group Corp., Tokyo (JP)

(21) Appl. No.: 19/564,309

(22) Filed: Mar. 12, 2026

(30) Foreign Application Priority Data
Mar. 19, 2025 (JP) 2025-044480

(51) Int. Cl. G06N 3/0475; G01C 21/34; G06F 40/205

(52) U.S. Cl. CPC G06N 3/0475; G01C 21/3446; G06F 40/205

(57) ABSTRACT

A system includes a processor that is configured to acquire image data and video information of accident-prone areas and non-accident-prone areas, add location information to the acquired data and store the data with the location information in a database, analyze the stored data using artificial intelligence to identify structural problems, generate improvement proposals by using a generative AI model based on an analysis result of the stored data, adjust the improvement proposals in consideration of user emotion, and output the adjusted improvement proposals.

### CROSS-REFERENCE TO RELATED APPLICATION

This application is based on and claims priority under 35 USC 119 from Japanese Patent Application No. 2025-044480 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional traffic safety improvement processes rely heavily on manual collection and analysis of accident data, on-site surveys, and subjective judgment by traffic engineers. As a result, identification of structural problems in accident-prone areas is time-consuming, inconsistent, and often limited to locations where serious accidents have already occurred. Furthermore, even when traffic environment data such as image data and video information is available, it is difficult to systematically analyze such data at scale and to derive objective improvement proposals tailored to specific locations. Existing systems also do not sufficiently utilize artificial intelligence, including generative models, to automatically generate concrete improvement proposals, nor do they consider user emotion in adjusting such proposals, which can lead to low acceptance and poor communication of recommended measures. Accordingly, there is a need for a system capable of automatically acquiring image data and video information from accident-prone and non-accident-prone areas, associating such data with location information, analyzing the data using artificial intelligence to identify structural problems, and generating and adjusting improvement proposals in a manner that reflects user emotion, thereby supporting more efficient and effective traffic safety planning.

### SUMMARY

In order to solve the above-described problem, an embodiment of the present invention provides a system comprising a processor. The processor is configured to acquire image data and video information of accident-prone areas and non-accident-prone areas, add location information to the acquired data, and store the data with the location information in a database. The processor is further configured to analyze the stored data using artificial intelligence to identify structural problems in the traffic environment, and to generate improvement proposals by using a generative AI model based on an analysis result of the stored data. In addition, the processor is configured to adjust the improvement proposals in consideration of user emotion and to output the adjusted improvement proposals. In some embodiments, the processor is configured to identify the accident-prone areas and the non-accident-prone areas based on location information by using at least one of a GPS system and a geographic information system, and to extract elements having a high possibility of accident occurrence from the image data and the video information by using a machine learning technique including a convolutional neural network. By these means, the system automatically links traffic environment data with geographic information, objectively detects structural problems, and generates and emotionally adjusts concrete improvement proposals, thereby addressing the limitations of conventional manual and static traffic safety analysis.

The term “system” refers to an aggregate of hardware and software components including at least one processor, memory, storage, communication interfaces, and associated programs configured to execute the claimed functions.

The term “processor” refers to any hardware element or combination of elements capable of executing instructions, including but not limited to a CPU, GPU, DSP, FPGA, ASIC, microcontroller, or a plurality of such elements operating in cooperation.

The term “image data” refers to still image information representing a traffic environment, including but not limited to digital photographs, extracted video frames, and bitmap or vector image formats obtained from cameras or similar imaging devices.

The term “video information” refers to moving image data comprising a plurality of temporally ordered frames that represent a changing traffic environment, including but not limited to digital video streams recorded by cameras or drive recorders.

The term “accident-prone areas” refers to geographic regions, road segments, or intersections in which traffic accidents or near-miss incidents occur with a frequency or severity that meets or exceeds a predetermined threshold.

The term “non-accident-prone areas” refers to geographic regions, road segments, or intersections in which traffic accidents or near-miss incidents occur with a frequency or severity below a predetermined threshold and are used as comparative or control data.

The term “location information” refers to information indicating a geographic position of an object or area, including but not limited to latitude and longitude coordinates, altitude, map coordinates, road identifiers, and associated timestamps.

The term “database” refers to any structured data storage system capable of storing, organizing, and retrieving data, including but not limited to relational databases, NoSQL databases, and distributed data stores.

The term “artificial intelligence” refers to computational techniques that perform tasks typically requiring human intelligence, including but not limited to machine learning, deep learning, pattern recognition, and statistical inference algorithms.

The term “structural problems” refers to physical or design-related deficiencies in the traffic environment, such as road geometry, signal placement, visibility, signage, and lane or sidewalk configuration, that contribute to an increased risk of traffic accidents.

The term “generative AI model” refers to an artificial intelligence model configured to generate new data or content, such as text, images, or design proposals, based on learned patterns from existing data, including but not limited to generative adversarial networks and transformer-based models. The term “improvement proposals” refers to suggested countermeasures or modifications to the traffic environment, including but not limited to changes to road layout, signal placement, signage, markings, lighting, or protective structures, that are intended to reduce accident risk.

The term “user emotion” refers to emotional states, preferences, attitudes, or reactions of a user, inferred or obtained by explicit input, that are considered in adjusting the content, tone, or presentation of the improvement proposals.

The term “GPS system” refers to a satellite-based positioning system, including the Global Positioning System and compatible or equivalent global navigation satellite systems, that provides geographic position and time information.

The term “geographic information system” refers to a system that captures, stores, analyzes, manages, and presents data related to geographic positions on the Earth's surface, including digital maps, road networks, and associated attribute data.

The term “machine learning technique” refers to a computational method that enables a model to learn patterns or relationships from training data and to make predictions or classifications on new data without being explicitly programmed for each possible input.

The term “convolutional neural network” refers to a type of artificial neural network that applies convolution operations to input data, typically image data, to automatically learn hierarchical spatial features for tasks such as classification, detection, and segmentation.

The term “elements having a high possibility of accident occurrence” refers to features or conditions detected in image data or video information, such as poor visibility, ambiguous lane boundaries, obstructed signals, or pedestrian-vehicle conflict points, that are associated with an elevated likelihood of traffic accidents.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

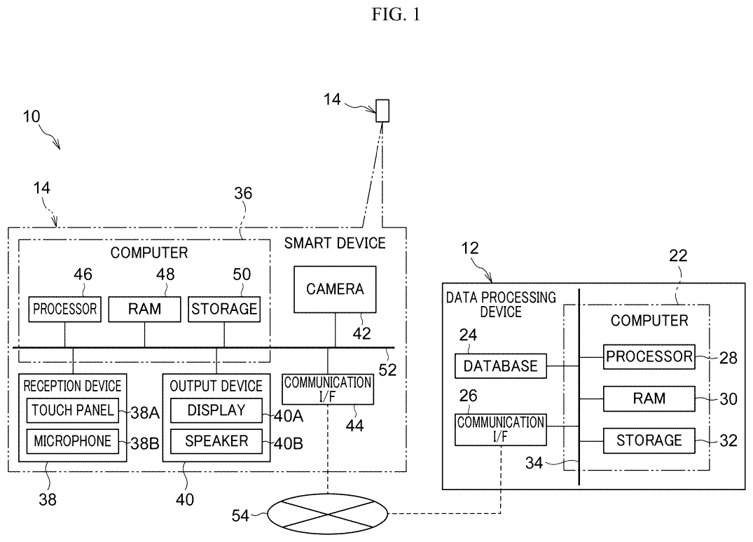

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

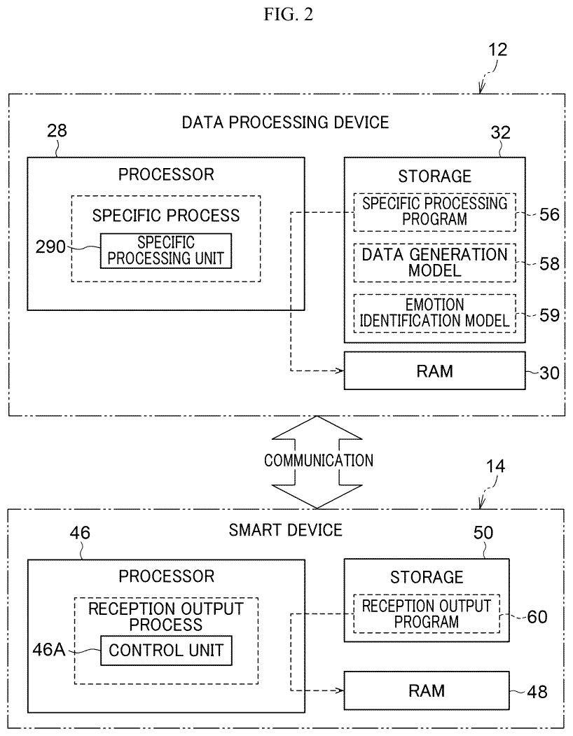

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional traffic safety analysis systems that utilize accident statistics and static geographic information systems often rely on manual inspection of maps, tabular data, and limited image samples. Such systems typically process pre-aggregated accident data without fully exploiting large-scale, time-series visual information captured in real driving environments. As a result, it is difficult to automatically identify fine-grained structural problems, such as subtle road-geometry deficiencies, degraded markings, or complex visibility constraints, that contribute to accident occurrence. Further, known systems that apply machine learning to traffic images generally output risk scores or classification labels, but they do not provide transparent, location-specific explanations and concrete, structured improvement plans that can be directly used by planners.

From a computer-technology standpoint, there is also a limitation in how heterogeneous data streams—such as high-volume video, positioning signals, derived environmental features, and traffic labels—are integrated and leveraged. Existing architectures often treat these data types in isolation, resulting in fragmented storage structures and ad hoc analysis pipelines. This fragmentation hinders scalable processing, degrades performance when correlating visual patterns with geographic locations, and complicates the generation of higher-level, interpretable outputs. Furthermore, interaction with generative AI models, where used, is typically performed in an unstructured, manual fashion. Prompt sentences are crafted on a case-by-case basis by human operators, and the system does not systematically generate, log, refine, and reuse prompts in a way that improves the quality, consistency, and traceability of the generated analyses over time.

In addition, known systems do not provide a comprehensive technical mechanism for transforming raw multi-modal traffic data into structured prompt sentences, submitting those prompts to a generative AI model, parsing the model's natural-language responses into machine-usable improvement-candidate data, and feeding user evaluations back into the prompt-generation logic. As a consequence, the computer itself is not effectively configured to orchestrate the end-to-end pipeline-ranging from acquisition of synchronized visual and positioning data, through feature extraction and comparative analysis between accident-concentrated and non-accident-concentrated regions, to generation and refinement of structured improvement plans mapped onto geospatial coordinates.

Accordingly, there is a need for an improved computer-implemented system that (i) acquires time-series visual information and standardized positioning data in a synchronized manner, (ii) converts the raw data into structured environmental feature data linked to location and region type, (iii) performs comparative data processing to derive structural problem candidates and safety-contributing features, (iv) automatically generates analysis-context information and prompt sentences for a generative AI model, (v) systematically structures and prioritizes improvement-candidate data from the model's responses, and (vi) updates prompt-generation logic based on accumulated analysis-history information and user-evaluation information. Such a system would constitute a concrete improvement in computer technology by providing a more effective data model, processing flow, and human-AI interaction mechanism for large-scale, location-specific traffic safety analysis.

The specific processing by the specific processing unit 290 of the data processing device 12 in Example 1 is realized by the following means.

The present invention provides a server comprising a processor and a storage structure, the processor being configured to receive, via wireless communication, time-series visual information from an imaging device or recording device mounted on a mobile body, acquire standardized positioning data from a positioning device substantially simultaneously with the visual information, associate the visual information with the positioning data on the basis of time information to generate position information, and store the associated visual information and position information in the storage structure in association with attribute information including identifiers, time information, and region-type information; to apply an image-analysis model to the stored visual information to extract environmental feature information including road-shape information, traffic-control information, pedestrian-space information, obstacle information, display information, and illumination information, and to accumulate feature data in which the environmental feature information is associated with the position information and the region-type information; to execute statistical processing or machine-learning processing on the feature data to compare traffic-accident-concentrated regions and non-traffic-accident-concentrated regions and to derive structural problem candidates specific to the traffic-accident-concentrated regions and structural feature candidates contributing to safety; to generate analysis-context information including explanatory-text information and comparison information for each analysis target location or analysis target section on the basis of the structural problem candidates, the structural feature candidates, the corresponding position information, and the environmental feature information; to generate a prompt sentence by formatting the analysis-context information into a natural-language text and to execute a query to a generative AI model by using the prompt sentence as input information; to extract, from response information obtained from the generative AI model, explanation information relating to traffic-accident occurrence factors and structural improvement-plan information corresponding to the explanation information, and to structure improvement-candidate data by associating the explanation information and the structural improvement-plan information with the position information and the analysis-context information; to perform prioritization processing and category-classification processing on the improvement-candidate data on the basis of at least one of a traffic-safety index, occurrence-frequency information, and user-evaluation information, thereby generating improvement-plan output information that is placeable on a geographic space; and to transmit the improvement-plan output information to an external terminal such that the external terminal outputs the improvement-plan output information in a format visualizable in association with the position information. This enables a concrete improvement in computer technology by providing an integrated, machine-orchestrated pipeline that transforms heterogeneous, large-scale traffic data into structured prompts for a generative AI model, converts the model's natural-language responses into machine-usable, geospatially anchored improvement plans, and iteratively refines prompt-generation and analysis behavior based on stored analysis-history information and user feedback, thereby enhancing the efficiency, scalability, and interpretability of computer-implemented traffic safety analysis.

The term “system” refers to an arrangement including at least one processor and at least one storage structure, configured to execute the functions recited in the claims as a coordinated whole.

The term “processor” refers to one or more hardware processing units, such as a central processing unit or a graphics processing unit, configured to execute instructions that implement the claimed functions.

The term “storage structure” refers to one or more hardware storage resources, such as a memory device or a non-volatile storage device, organized to store data including visual information, position information, attribute information, feature data, analysis-history information, and improvement-candidate data.

The term “mobile body” refers to any movable object or platform, such as a vehicle or a mobile robot, on which an imaging device or a recording device and a positioning device are mounted.

The term “imaging device” refers to a hardware device configured to capture visual information of a scene, such as a camera or an optical sensor.

The term “recording device” refers to a hardware device configured to record visual information over time, such as a video recorder or a drive recorder.

The term “time-series visual information” refers to visual data acquired in chronological order, such as a sequence of images or frames constituting a moving image.

The term “wireless communication” refers to a data communication method using electromagnetic waves without a wired connection, including but not limited to radio communication, short-range communication, and wireless local-area network communication.

The term “positioning device” refers to a hardware device or module configured to output data indicative of a geographic position, such as a satellite-based positioning receiver or a terrestrial positioning sensor.

The term “standardized positioning data” refers to position-related data output in a predetermined format, such as latitude, longitude, and time information formatted according to a positioning protocol.

The term “position information” refers to data that specifies a geographic location of a corresponding piece of visual information, and that is derived by associating the visual information with the standardized positioning data.

The term “time information” refers to data indicating temporal information, such as timestamps or time codes, used to associate visual information with positioning data.

The term “traffic-accident-concentrated region” refers to a geographic region in which traffic accidents are known or determined to occur with relatively high frequency.

The term “non-traffic-accident-concentrated region” refers to a geographic region in which traffic accidents are known or determined to occur with relatively lower frequency compared to a traffic-accident-concentrated region.

The term “attribute information” refers to data items associated with visual information or position information, including at least an identifier, time information, and region-type information.

The term “identifier” refers to data used to uniquely or distinctively identify an entity such as a visual information item, a session, a region, or a record.

The term “region-type information” refers to data indicating a classification of a region, including at least whether the region is a traffic-accident-concentrated region or a non-traffic-accident-concentrated region.

The term “image-analysis model” refers to a computational model, implemented by software and executed by hardware, configured to analyze visual information and output detection results, classifications, or feature representations.

The term “environmental feature information” refers to information representing characteristics of a traffic environment around a road, including at least road-shape information, traffic-control information, pedestrian-space information, obstacle information, display information, and illumination information.

The term “road-shape information” refers to information describing the geometric form and configuration of a road, such as curvature, number of lanes, lane width, and alignment.

The term “traffic-control information” refers to information relating to control of traffic flow, such as the presence, type, and status of signals, signs, or control devices.

The term “pedestrian-space information” refers to information describing spaces designated or used for pedestrians, such as sidewalks, crosswalks, pedestrian islands, or pedestrian zones.

The term “obstacle information” refers to information describing objects that may obstruct movement or visibility in a traffic environment, such as parked objects, barriers, or physical obstructions.

The term “display information” refers to information concerning visual indications provided to road users, such as road markings, sign faces, or other displayed symbols.

The term “illumination information” refers to information describing lighting conditions of a traffic environment, such as brightness level, presence of lighting facilities, or distribution of light.

The term “feature data” refers to data in which environmental feature information is associated with corresponding position information and region-type information for analysis.

The term “statistical processing” refers to data processing techniques that compute statistical measures or comparisons, such as averages, variances, distributions, or correlations, based on feature data.

The term “machine-learning processing” refers to computational processing using an algorithm that learns patterns or models from data to perform tasks such as classification, regression, or clustering on the feature data.

The term “structural problem candidate” refers to a hypothesized structural characteristic of a traffic environment, derived from analysis of feature data, that is likely to contribute to occurrence of traffic accidents.

The term “structural feature candidate contributing to safety” refers to a hypothesized structural characteristic of a traffic environment, derived from analysis of feature data, that is likely to reduce or mitigate occurrence of traffic accidents.

The term “analysis target location” refers to a specific geographic point or area for which analysis-context information is generated.

The term “analysis target section” refers to a specific contiguous road segment or region for which analysis-context information is generated.

The term “analysis-context information” refers to information that provides contextual description of a traffic environment for analysis, including at least explanatory-text information, comparison information, position information, and environmental feature information.

The term “explanatory-text information” refers to text data that explains or describes characteristics or conditions of a traffic environment or structural issue.

The term “comparison information” refers to information that describes similarities or differences between traffic-accident-concentrated regions and non-traffic-accident-concentrated regions, or between different locations or sections.

The term “prompt sentence” refers to a text, including at least part of the analysis-context information, formatted as an input instruction or query for a generative AI model.

The term “generative AI model” refers to a machine learning model that generates output data, such as natural-language text, in response to input data including a prompt sentence.

The term “query to a generative AI model” refers to a computer-implemented operation for providing a prompt sentence and optional additional data to a generative AI model to obtain response information.

The term “response information” refers to data output by a generative AI model in response to a query, including at least natural-language text.

The term “explanation information relating to traffic-accident occurrence factors” refers to information contained in response information that describes potential reasons, mechanisms, or contributing factors for traffic accidents in a given environment.

The term “structural improvement-plan information” refers to information contained in response information that describes proposed structural changes or interventions to improve traffic safety.

The term “improvement-candidate data” refers to structured data in which explanation information and structural improvement-plan information are associated with corresponding position information and analysis-context information.

The term “traffic-safety index” refers to a numerical or categorical measure indicating a level of safety or risk in a traffic environment, which may be computed from accident records, exposure data, or derived indicators.

The term “occurrence-frequency information” refers to information describing a frequency or rate of occurrence of traffic accidents or related events for a given region or location.

The term “user-evaluation information” refers to information indicating evaluations, feedback, or assessments provided by users regarding improvement-candidate data or improvement-plan output information.

The term “prioritization processing” refers to processing that assigns an order of importance or urgency to improvement-candidate data based on at least one criterion, such as a traffic-safety index, occurrence-frequency information, or user-evaluation information.

The term “category-classification processing” refers to processing that assigns improvement-candidate data to one or more categories, such as types of structural improvements or thematic groups.

The term “improvement-plan output information” refers to information representing one or more improvement plans, structured and formatted for presentation and geospatial placement in association with position information.

The term “geographic space” refers to a representation of physical space based on geographic coordinates or geospatial reference systems.

The term “external terminal” refers to an external computing device, such as a client device or display device, configured to receive improvement-plan output information from the server and present the information to a user.

The term “analysis-history information” refers to information stored in the storage structure that records past prompt sentences, response information, processing results, and associated metadata used in previous analyses.

The term “prompt-generation control processing” refers to processing that uses analysis-history information and user-evaluation information to modify or update the components, expression format, or explanation level of future prompt sentences.

The term “geospatial-information processing” refers to processing that uses geographic coordinates or geospatial reference data to perform operations such as aggregation, mapping, or spatial analysis.

The term “road section” refers to a delineated portion of a road network, defined by geographic boundaries or reference points, used as a unit for analysis and aggregation.

The term “intersection” refers to a location where two or more road sections cross, merge, or diverge, and that is treated as a unit for analysis and aggregation.

The term “comprehensive improvement-plan output information” refers to improvement-plan output information generated by integrating multiple prompt sentences and corresponding pieces of response information for a plurality of locations or sections within a wide-area region.

In one embodiment, a server implements a traffic safety analysis system that collects and processes time-series visual information and positioning data from mobile bodies such as vehicles, derives structured environmental features, generates analysis-context information, and interacts with a generative AI model using a prompt sentence to obtain location-specific explanations and improvement plans. The server stores and manages all intermediate data in defined data structures so that the system can be implemented and reproduced on general-purpose computer hardware.

The server includes at least one processor, such as a multi-core central processing unit and optionally one or more graphics processing units, and at least one storage device, such as a main memory and a non-volatile storage device. The server executes an operating system, such as a general-purpose server operating system, and application software implemented, for example, using a programming language runtime and libraries. The server communicates with imaging devices or recording devices and positioning devices mounted on mobile bodies via wireless communication using a wireless network interface compliant with a wireless communication standard such as a wireless local area network standard or a short-range radio communication standard.

The server receives time-series visual information from a camera or drive recorder mounted on the mobile body. The camera outputs video frames encoded, for example, in a moving image format such as an H.264-based container format. The server receives packets via a network stack of the operating system, reconstructs the transport stream, and decodes the video using a media processing library such as a multimedia framework. The server stores each frame, or groups of frames, in a frame buffer in main memory, with a frame index and presentation timestamp attached in a frame record structure.

The server acquires standardized positioning data from a positioning device mounted on the mobile body. The positioning device outputs a stream of positioning messages, such as standardized sentences containing latitude, longitude, and universal time. The server reads this stream through a communication interface, and parses each sentence using a parser module that extracts numerical latitude, longitude, speed, heading, and time. The server stores each parsed message in a positioning record structure that includes fields such as position identifier, timestamp, latitude, longitude, speed, heading, and quality flag.

The server associates the frame record structures with the positioning record structures by matching timestamps. The server uses interpolation when the timestamps do not exactly coincide; for example, the server finds two positioning records with timestamps just before and after the frame timestamp and linearly interpolates latitude and longitude. The server generates position information for each frame or frame group and stores it in a visual-position mapping table in a relational database. This table includes at least a visual identifier, a position identifier, a timestamp, a region-type flag indicating whether the location belongs to a traffic-accident-concentrated region or a non-traffic-accident-concentrated region, and an attribute field for additional metadata.

The server applies an image-analysis model to the stored visual information. In one embodiment, the server uses a convolutional neural network-based object detection model implemented with a deep learning framework. The model architecture may include a backbone network with convolutional layers, normalization layers, and nonlinear activation layers, followed by feature pyramid layers and detection heads that output bounding boxes and class probabilities. The server first samples frames from each video segment at a configured interval to reduce computational load while preserving sufficient temporal coverage. The server then passes each sampled frame as a tensor to the neural network, and obtains detection outputs including object categories such as lane markings, traffic lights, traffic signs, pedestrian crossings, guardrails, sidewalks, vehicles, obstacles, and luminance patterns.

The server converts the raw detection outputs into environmental feature information. For example, the server computes lane width statistics from detected lane markings, curve radius proxies from the geometry of lane lines across consecutive frames, lighting uniformity indices from luminance histograms, and visibility measures for traffic signals and signs from the ratio of visible pixels and detection confidence scores. The server aggregates these frame-level features into segment-level environmental feature records in a road-feature table. Each record includes a segment identifier, aggregated metrics for road-shape information, traffic-control information, pedestrian-space information, obstacle information, display information, and illumination information, as well as associated position information and region-type information.

The server performs statistical processing and machine-learning processing on the environmental feature records. In one embodiment, the server uses a gradient boosting classifier implemented in a machine learning library. The server treats each segment-level record as an input feature vector, whose components include, for example, lane width, number of lanes, presence or absence of crosswalks, crosswalk marking quality index, number and type of traffic signs, nighttime luminance mean and variance, presence of guardrails, and obstruction scores. The server trains the classifier on labeled data, where the target label indicates whether a segment belongs to a traffic-accident-concentrated region. During training, the server uses a loss function such as logistic loss and an optimization method such as gradient boosting over decision trees. The server splits the data into training and validation sets, and may apply techniques such as class weighting or sampling to address label imbalance.

The server derives structural problem candidates by analyzing feature importance values and prediction behavior of the classifier. For example, the server computes global feature importance scores, such as gain-based importance, and local explanations for specific segments, such as contribution values for each feature. When the classifier predicts that a segment is likely an accident-concentrated segment and assigns high importance to features such as low luminance, absence of a dedicated turning lane, or low marking quality, the server registers these features as structural problem candidates for that segment. Conversely, for non-accident-concentrated segments, features identified as protective, such as clear markings and adequate lighting, are registered as structural feature candidates contributing to safety.

The server generates analysis-context information for each analysis target location or section. The server groups contiguous segment records into analysis units, such as a specific curve, intersection, or road stretch. For each analysis unit, the server generates explanatory-text information by filling a template with computed metrics and classifier-derived interpretations. For example, the server may generate text such as: “This intersection has two approach lanes without a dedicated left-turn lane. The lane markings are severely degraded, and nighttime luminance is below a threshold compared to similar safe intersections.” The server also generates comparison information by selecting control units from non-accident-concentrated regions with similar traffic function and comparing key metrics. For example, the server may generate text such as: “In contrast, a similar intersection in a non-accident-concentrated region has a dedicated left-turn lane, clear crosswalk markings, and higher average luminance.”

The server then generates a prompt sentence by formatting the analysis-context information into natural-language input for a generative AI model. The server may construct prompts that explicitly include the structural problem candidates, the structural feature candidates, and comparison summaries. Example prompt sentences include:

“The server has collected video-based structural features and GPS locations for an accident-prone intersection and a similar non-accident-prone intersection. The accident-prone intersection has no left-turn lane, poor lighting, and faded markings. The non-accident-prone intersection has a left-turn lane, good lighting, and clear markings. Using domain knowledge of traffic safety, identify likely structural causes of accidents at the accident-prone intersection and propose specific improvement measures.”

“Using the video descriptions and GPS-based location information for this road curve, propose specific infrastructure improvements to reduce rear-end collisions. Consider road geometry, signage, lighting, visibility, and lane markings. Present the proposals as a prioritized list with justifications.” “The server has derived that segments with low luminance, absence of guardrails on the outer side of a curve, and insufficient advance warning signs show significantly higher accident occurrence. Explain the possible mechanisms and propose structural interventions to mitigate these risks.” The server sends the prompt sentence to a generative AI model. In one embodiment, the generative AI model is a transformer-based neural network with an encoder-decoder or decoder-only architecture, trained on large-scale text corpora. The model comprises stacked self-attention layers, feed-forward layers, and normalization layers. The server transmits the prompt as a sequence of tokens to the generative AI model via an inference API, with parameters such as maximum output length and sampling temperature. The server receives natural-language response information from the model, which may include descriptions of accident occurrence mechanisms and proposed structural improvements.

The server parses the response information to extract explanation information and structural improvement-plan information. The server may use rule-based parsing or an auxiliary classifier to identify bullet lists, numbered steps, and key phrases that correspond to improvement actions, such as “install advance warning signs 150 meters before the curve,” “add a dedicated left-turn phase at the signal,” or “repaint crosswalks with high-visibility markings.” The server associates each extracted improvement with the relevant analysis unit and its position information, and stores the results as improvement-candidate data in an improvement table. Each record includes a location identifier, improvement category (for example, signage, lighting, geometry, marking, pedestrian facility), textual description, and links to the underlying features and problem candidates that motivated the suggestion.

The server performs prioritization processing on the improvement-candidate data. The server computes a priority score for each proposal using a scoring function that may combine a traffic-safety index, accident occurrence frequency for the location, classifier-estimated risk level, and user-evaluation information from previous iterations. The server, for example, may assign a higher weight to locations with both high accident frequency and strong indication of structural deficiencies, and to proposals that address multiple structural problem candidates simultaneously. The server then performs category classification to group proposals into categories and subcategories. These operations allow the server to generate improvement-plan output information structured as a geospatially indexed list or map overlay, which can be efficiently retrieved and rendered on terminals.

The server transmits the improvement-plan output information to a terminal operated by a user such as a traffic engineer or road administrator. The terminal may be a tablet, smartphone, or personal computer configured to execute a client application or a web browser. The terminal receives the geospatially encoded improvement-plan output information, displays a digital map, and overlays icons or colored segments at the corresponding coordinates. When the user selects a location, the terminal displays the explanation information, the list of proposed structural improvements, and optionally representative visual frames from the underlying video. The user can then review, annotate, or rate the proposals. The terminal transmits user-evaluation information back to the server, where it is stored as analysis-history information.

The server uses the accumulated analysis-history information and user-evaluation information to perform prompt-generation control processing. For example, the server analyzes which types of prompt constructions tend to lead to proposals that users later accept with high ratings. The server may adjust the level of detail in the analysis-context information, the order and emphasis of structural problem candidates, and the explicit constraints in the prompt (such as asking for “no more than five prioritized items” or “focus on low-cost interventions”). The server stores parameterizations of different prompt templates and updates them using optimization rules that seek to maximize alignment between model output and positive user evaluations. This adaptive prompt-generation mechanism improves the consistency, relevance, and technical depth of subsequent generative AI model outputs, beyond simple manual prompt crafting.

The server thereby implements a specific technical pipeline that improves computer technology in several ways. First, the server optimizes data flow and storage by using synchronized frame-position mappings and aggregated feature records, which reduce redundant computations and enable efficient spatial queries. This directly improves processing speed and scalability when large amounts of traffic video are processed. Second, the server applies a combination of supervised learning models, feature importance analysis, and structured prompt construction to transform raw sensor data into high-level semantic context tailored for generative AI input. This non-conventional interaction pattern with a generative AI model—where the server automatically generates, logs, analyzes, and refines prompts according to explicit performance criteria-enhances the accuracy and stability of model-driven analyses without human-crafted prompts.

Third, the server's structured extraction and prioritization of improvement-candidate data transform the generative AI model's unstructured text into machine-usable records aligned with geospatial coordinates and specific categories. This contributes to improved data management, enabling the server to index, retrieve, and compare proposals for different regions using database queries rather than manual reading. Fourth, the integration of user feedback into prompt-generation control and proposal prioritization provides a closed-loop adaptation mechanism that incrementally refines the computational behavior of the system, improving precision and reducing systematic errors over time.

The server uses a concrete architecture in which an input-acquisition module, a synchronization and storage module, a feature-extraction module, a comparative-analysis module, a prompt-generation module, a generative-AI interaction module, an improvement-structuring module, and a visualization/feedback module are implemented as separate software components. Each module communicates via defined data structures and interfaces. For example, the feature-extraction module outputs a feature vector structure and a region label; the comparative-analysis module outputs a list of structural problem candidates; the prompt-generation module outputs a prompt-string object; the generative-AI interaction module returns a response-string object; and the improvement-structuring module outputs an improvement-record list. This modular design allows implementation on distributed architectures where different modules may run on different machines, yet the technical behavior remains consistent with the claimed invention.

The terminal cooperates with the server by providing visualization and user interaction functions but does not replicate the core analytical processing. The terminal retrieves improvement-plan output information, renders map overlays using a mapping library, and provides interfaces for users to input evaluations and comments. The user interacts with the terminal by inspecting geospatial displays, reading explanations and proposals, and entering feedback. The workflow allows traffic professionals to apply domain expertise at the decision stage, while the computationally intensive and technically complex data integration, analysis, and prompt-based generation processes are performed by the server.

Alternative embodiments are possible within the same inventive concept. The server may use different image-analysis models, such as segmentation networks, to obtain lane boundaries and pedestrian areas more precisely. The server may use alternative machine learning models, such as random forests, support vector machines, or neural networks with attention mechanisms, for risk classification. The generative AI model may be hosted locally on the same server or remotely on a separate inference server, and may be fine-tuned on traffic-safety-related corpora to specialize its responses. The server may adjust the frequency of frame sampling and feature aggregation depending on available computational resources and required spatial resolution. The server may also adopt different optimization strategies for prompt-generation control, such as reinforcement learning methods that treat prompt templates as policies and user acceptance as rewards.

Through these concrete computational structures, data models, and algorithms, the server configures the computer system to perform traffic safety analysis in a manner that is not a mere automation of manual review, but rather a technically improved processing pipeline. The system yields increased processing throughput for large visual datasets, enhanced accuracy and interpretability in identifying structural problems, reduced communication overhead by transmitting only aggregated and prioritized improvement plans, and adaptive refinement of generative AI interaction strategies, thereby achieving technical effects that are rooted in the operation of the computer itself.

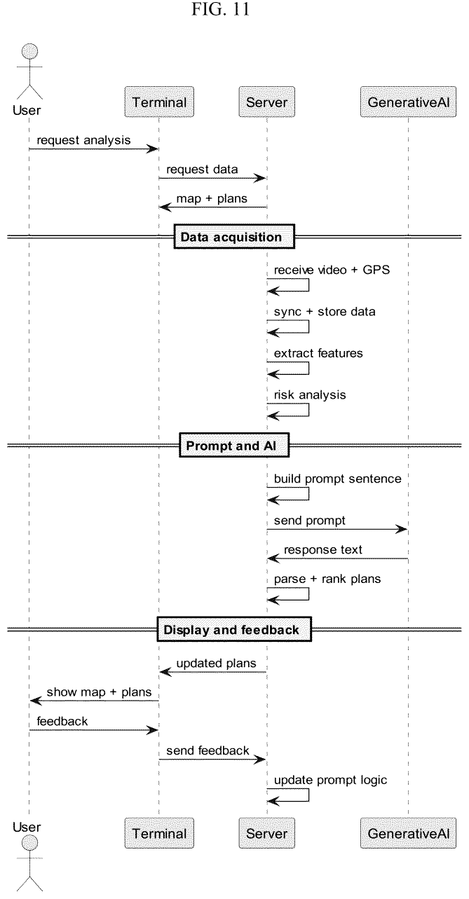

The following describes the processing flow using FIG. 11.

### Step 1:

The server receives time-series visual information from an imaging device or recording device mounted on a mobile body by using wireless communication.

The server uses a wireless network interface to accept packets containing encoded video frames, and the server reconstructs a continuous video stream from the received packets.

Input: encoded video packets received over a wireless communication channel.

Output: decoded video frames stored in a frame buffer, each frame having an index and a timestamp.

The server decodes the video packets using a media processing library, converts compressed bitstreams into pixel arrays, and attaches frame indices and presentation timestamps to each decoded frame before writing them into a memory buffer.

### Step 2:

The server acquires standardized positioning data from a positioning device that outputs positioning messages.

The server reads a stream of positioning messages, parses each message to extract latitude, longitude, speed, heading, and time information, and stores the parsed values as positioning records.

Input: raw positioning messages containing standardized positioning data.

Output: positioning records including timestamp, latitude, longitude, speed, and heading.

The server executes a parsing routine that identifies message types, validates checksums, converts coordinate strings into numeric values, and discards messages that fail integrity checks, thereby generating clean positioning records.

### Step 3:

The server synchronizes the video frames with the positioning records to generate position information for each frame or frame group.

The server compares frame timestamps with positioning timestamps, finds nearest or bracketing positioning records, and interpolates position when necessary to assign a geographic location to each frame.

Input: frame records with timestamps and positioning records with timestamps and coordinates.

Output: synchronized visual-position mappings associating each frame identifier with position information.

The server computes time differences between each frame and candidate positioning records, selects the best match, and calculates interpolated latitude and longitude using linear interpolation when two positioning records surround a frame in time.

### Step 4:

The server stores the synchronized visual-position mappings in a storage structure such as a relational database and an associated file system or object store.

The server writes video segments or frame groups to persistent storage and inserts metadata records that link each stored visual unit with its position information, time information, and region-type information.

Input: synchronized visual-position mappings and raw visual data.

Output: database records that contain identifiers, time information, position information, and region-type flags, as well as stored visual files referenced by those records.

The server creates or updates database tables, assigns unique identifiers, writes rows containing frame or segment IDs, file paths, timestamps, latitude, longitude, and region-type labels, and commits transactions to guarantee data consistency.

### Step 5:

The server determines region-type information indicating whether a position belongs to a traffic-accident-concentrated region or a non-traffic-accident-concentrated region.

The server uses geographic definitions of regions, such as polygon boundaries or grid cells, and compares the stored position information with these definitions to assign region-type labels.

Input: position information (latitude and longitude) and predefined geographic region definitions.

Output: updated database records where each position is associated with a region-type label (accident-concentrated or non-accident-concentrated).

The server executes spatial queries or point-in-polygon checks, evaluates whether each position falls within an accident-concentrated boundary, and sets or updates the region-type flag accordingly.

### Step 6:

The server extracts visual frames or sampled frames from stored visual data for image analysis.

The server reads frame sequences from storage based on identifiers, selects frames at predefined intervals, and prepares them as input tensors for an image-analysis model.

Input: stored visual files and frame identifiers.

Output: batches of preprocessed images or tensors ready for model inference.

The server decodes frames from the stored video files, resizes and normalizes pixel values, converts color formats if necessary, and arranges frames into batch tensors with appropriate dimensions for processing by a neural network.

### Step 7:

The server applies an image-analysis model to the preprocessed frames to detect traffic-environment elements and generate detection outputs.

The server runs a convolutional neural network or similar model on a processing unit, feeding the image tensors into the model and obtaining bounding boxes, class labels, and confidence scores for detected objects.

Input: batches of preprocessed image tensors.

Output: detection results containing object categories, bounding box coordinates, and confidence scores for each frame.

The server propagates the image tensors through convolutional layers, pooling layers, and detection heads, performs non-maximum suppression on overlapping bounding boxes, and filters detections below a confidence threshold to reduce noise.

### Step 8:

The server converts detection results into environmental feature information for each frame and then aggregates these features at a segment or location level.

The server computes metrics such as lane width, presence or absence of crosswalks, number and type of traffic signs, lighting uniformity, presence of guardrails, and obstruction indicators, and aggregates these across frames belonging to the same road section.

Input: detection results per frame and frame-to-segment associations.

Output: environmental feature records per segment, including road-shape information, traffic-control information, pedestrian-space information, obstacle information, display information, and illumination information.

The server calculates statistical measures such as averages, percentages, and frequencies for each feature, merges multiple frame-based measurements into a single record per segment, and writes the aggregated values into a road-feature table with references to position and region-type information.

### Step 9:

The server performs statistical processing and machine-learning processing on the environmental feature records to derive structural problem candidates and safety-related feature candidates.

The server trains or applies a classifier that takes feature vectors as input and outputs a probability or label indicating whether a segment is likely accident-concentrated, and the server analyzes feature importance values to identify influential features.

Input: environmental feature records labeled by region type (accident-concentrated or non-accident-concentrated).

Output: lists of structural problem candidates and structural feature candidates contributing to safety, each associated with specific segments and feature metrics.

The server feeds feature vectors into a machine-learning algorithm, computes loss values against ground-truth labels, updates model parameters via gradient-based optimization during training, and, after training, extracts feature importance and local contribution scores to infer which structural characteristics are associated with high accident likelihood or improved safety.

### Step 10:

The server generates analysis-context information for each analysis target location or section by combining environmental feature information, structural problem candidates, structural feature candidates, and position information.

The server constructs explanatory-text descriptions and comparison summaries that describe the conditions of an accident-concentrated location relative to non-accident-concentrated locations.

Input: structural problem candidates, structural feature candidates, environmental feature records, and position information.

Output: analysis-context records holding explanatory-text information, comparison information, and location identifiers.

The server fills text templates with numeric values and interpreted feature roles, selects appropriate contrasting examples, and assembles coherent narrative descriptions that summarize the key structural issues and protective features for each analysis unit.

### Step 11:

The server generates a prompt sentence for a generative AI model by formatting the analysis-context information into a natural-language query.

The server concatenates explanatory-text information, comparison information, and explicit instructions into a single text string that is optimized for eliciting detailed, relevant responses from the generative AI model.

Input: analysis-context records containing explanatory and comparison texts.

Output: prompt sentences posed as natural-language queries.

The server inserts headings, bullet-like phrases, or labeled sections into the text, orders the information so that problem descriptions precede requests for solutions, and attaches constraints such as “propose specific infrastructure improvements” or “explain likely accident mechanisms” to form a clear and directive prompt sentence.

### Step 12:

The server submits the prompt sentence to a generative AI model and receives response information.

The server sends the prompt sentence to a transformer-based generative AI model via an inference API, specifying parameters such as maximum response length and generation temperature, and then collects the generated text output.

Input: prompt sentences and generation parameters.

Output: response texts containing explanation information and structural improvement-plan suggestions.

The server tokenizes the prompt, transmits the token sequence to the generative AI model, waits for the model to generate output tokens, decodes the tokens back into text, and records both the prompt and the response in an analysis-history store.

### Step 13:

The server parses the response information to extract explanation information and structural improvement-plan information and converts them into structured improvement-candidate data.

The server analyzes the response text to identify phrases that describe accident causes and proposed interventions, tags them with categories, and associates them with the corresponding locations.

Input: response texts and associated analysis-context records.

Output: structured improvement-candidate records including explanation fields, improvement-plan fields, location identifiers, and categories.

The server applies pattern-matching rules, keyword lists, or auxiliary classifiers to split the response into individual suggestions, normalizes similar suggestions into standard improvement categories, and stores each suggestion as a separate record with references to the original prompt and response for traceability.

### Step 14:

The server calculates priority scores and assigns categories to the improvement-candidate data to generate improvement-plan output information.

The server evaluates each improvement candidate using criteria such as accident frequency, classifier-estimated risk, potential effect on multiple problem candidates, and user evaluations from prior cycles, and then orders and groups candidates accordingly.

Input: improvement-candidate records, accident statistics, risk scores, and stored user-evaluation information.

Output: prioritized and categorized improvement-plan output records ready for geospatial visualization.

The server executes a scoring function that combines normalized accident occurrence rates, importance weights of addressed features, and historical acceptance rates, sorts candidates by score within each region, assigns category labels, and formats the results into data structures that include coordinates, textual descriptions, category tags, and priority levels.

### Step 15:

The server transmits the improvement-plan output information to a terminal for visualization in association with geographic locations.

The server exposes an interface through which the terminal requests improvement plans for a specified area, and the server responds with the prioritized improvement-plan output records including geographic coordinates.

Input: requests from terminals specifying geographic regions or locations.

Output: response payloads containing improvement-plan output information and associated position information.

The server executes geospatial queries to retrieve all improvement-plan records within the requested area, packs the records into a response message, and sends the message to the terminal over a network connection.

### Step 16:

The terminal displays the improvement-plan output information on a digital map and provides an interface for user evaluation.

The terminal plots icons or colored overlays on a map at the positions corresponding to the improvement-plan records, and shows explanatory and improvement details when the user selects any location.

Input: improvement-plan output information and geographic coordinates received from the server.

Output: visual representation of improvement plans on the terminal screen and user-input events representing evaluations or comments.

The terminal renders the map, draws markers and legends, outputs text panels containing explanation and proposed improvements, and collects user inputs such as approvals, rejections, priority adjustments, and free-text comments.

### Step 17:

The user reviews the displayed improvement plans and provides evaluations and feedback through the terminal.

The user inspects each proposed improvement, considers the explanation and context, and inputs a rating, selection, or comment indicating the user's assessment.

Input: visualized improvement plans and contextual information presented on the terminal.

Output: user-evaluation information including ratings, decisions, and comments.

The user operates input devices such as touchscreens, keyboards, or pointing devices to select proposals, assign scores or statuses, and enter additional notes that express agreement, concerns, or alternative suggestions.

### Step 18:

The terminal transmits the user-evaluation information back to the server for storage as analysis-history information.

The terminal packages the user-evaluation data with identifiers of the corresponding improvement-candidate records and sends this package to the server via a communication interface.

Input: user-evaluation information and associated improvement-plan identifiers.

Output: evaluation messages delivered to the server.

The terminal constructs data objects containing proposal IDs, user IDs or roles, timestamps, ratings, and comments, and sends these objects to the server using a defined communication protocol.

### Step 19:

The server stores the user-evaluation information as part of analysis-history information and updates prompt-generation control parameters.

The server associates each evaluation entry with the corresponding prompt sentence, response text, and improvement-candidate record, and adjusts internal parameters that govern how future prompt sentences are constructed.

Input: evaluation messages containing user-evaluation information and identifiers.

Output: updated analysis-history records and revised prompt-generation parameters.

The server writes the evaluations into a history table, links entries to prompts and responses via identifiers, computes statistics such as acceptance rates per prompt pattern, and modifies template weights or rules so that future prompt sentences emphasize elements that historically yield higher user satisfaction and technical relevance.

### Step 20:

The server applies the updated prompt-generation parameters during subsequent analyses, thereby refining the interaction with the generative AI model and improving the quality of generated improvement plans over time.

The server uses the revised templates and rules to create new prompt sentences that better align with user expectations and safety goals, based on the previously stored analysis-history information.

Input: updated prompt-generation parameters and new analysis-context information for subsequent locations.

Output: refined prompt sentences and, as a result, improved response texts from the generative AI model in later processing cycles.

The server selects appropriate template variants according to context, adjusts the level of detail, ordering, and emphasis in the prompt sentences, and reuses successful phrasing patterns, leading to more precise, actionable, and consistent outputs from the generative AI model across iterations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional driver-assistance and traffic-safety systems typically rely on fixed rule sets, static geographical risk maps, or simple threshold logic operating on sensor readings. Such systems often classify risk based on coarse location categories or basic object detection, without deeply integrating heterogeneous data sources such as real-time visual information, precise positional information, and rich historical traffic event information. As a result, the systems may produce overly conservative or overly permissive warnings, fail to adapt to evolving traffic patterns, and provide limited explanatory feedback to vehicle operators.

Moreover, in many existing architectures, the generation of warning messages is implemented as a collection of hand-crafted templates that are manually mapped to risk levels. This template-based approach does not scale well with increasing scenario complexity, cannot flexibly reflect nuanced combinations of environmental attributes and historical risk factors, and often yields generic messages that are not contextually optimized for user comprehension or timely reaction. Consequently, the human-machine interface layer becomes a bottleneck that limits the practical effectiveness of the underlying risk assessment logic.

From a computer-technology standpoint, there is also a lack of tightly integrated processing pipelines that (i) ingest and normalize high-volume, high-dimensional sensor data in near real time, (ii) compute a numerical risk index using coordinated machine learning and statistical models that combine visual features and historical features, and (iii) automatically generate structured evaluation result information suitable as machine-readable input for a generative artificial intelligence model. In many deployments, these stages are loosely coupled or manually stitched together, leading to increased latency, higher resource consumption, and difficulty in maintaining system correctness and robustness at scale.

Furthermore, existing systems generally do not leverage generative artificial intelligence models in a systematic manner to translate internal machine-readable evaluation results into human-oriented, situation-specific natural language messages. In the absence of an automatically constructed and semantically rich prompt sentence that encapsulates a computed risk level, its justification, and environmental attributes, a generative artificial intelligence model cannot be reliably employed to produce consistent and safety-appropriate guidance. This gap prevents systems from fully exploiting generative models to improve clarity, personalization, and adaptability of safety warnings while maintaining deterministic control over the underlying risk computation.

Accordingly, there is a need for an improved computer-implemented system that (a) unifies acquisition and storage of visual and positional information with historical traffic event information, (b) computes a numerical risk index and a staged risk level through integrated machine learning and statistical processing, (c) generates structured evaluation result information including justification data, and (d) uses such evaluation result information to automatically construct prompt sentences for a generative artificial intelligence model, thereby enabling the generation of context-aware, natural language warning messages. Such a system should improve the technical efficiency, scalability, and reliability of the data-processing pipeline itself, and enhance the quality and timeliness of warnings delivered to users.

The specific processing by the specific processing unit 290 of the data processing device 12 in Application Example 1 is realized by the following means.

The present invention provides a server comprising at least one processor and at least one memory storing instructions which, when executed by the at least one processor, cause the at least one processor to acquire environmental visual information and positional information related to traffic conditions from one or more terminals, associate the acquired visual information and positional information with each other and store associated information in a storage region, obtain historical information in which stored visual information and positional information are associated with past traffic event information, execute inference processing using a machine learning model to calculate, on the basis of the visual information and the historical information, a numerical index representing a risk level of occurrence of a traffic event, classify a staged risk level on the basis of the numerical index and a predetermined threshold, generate evaluation result information in which warning content to be presented to a vehicle operator is structured on the basis of the classified risk level and environmental attribute information corresponding to the visual information, generate and transmit a prompt sentence including the evaluation result information as input information to a generative artificial intelligence model so that the generative artificial intelligence model generates a natural language message including a situation explanation and the warning content, acquire the natural language message output from the generative artificial intelligence model, convert the natural language message into output data including at least audio information or visual information, and provide warning information to a user by using the output data. This enables an integrated computer-implemented processing pipeline that efficiently fuses real-time sensor data with historical traffic event data to compute a justified numerical risk index, programmatically constructs semantically rich prompt sentences for a generative artificial intelligence model, and automatically produces context-aware natural language warnings, thereby improving the technical performance, scalability, and responsiveness of traffic risk assessment and driver notification functions.

The term “environmental visual information” refers to image data or video data representing a physical environment around a vehicle or road segment, the data being captured by an imaging device and processed in digital form for analysis by the system.

The term “positional information” refers to data indicating a geographical location of a vehicle or observation point, including at least coordinates or equivalent location identifiers obtained from a positioning technology.

The term “traffic conditions” refers to states or attributes of a traffic environment, including at least vehicle flow, road layout, intersection configuration, and presence of potential hazards in a road network.

The term “storage region” refers to any computer-readable memory or data store, including volatile or non-volatile media, configured to retain associated visual information, positional information, and related metadata for later processing.

The term “historical information” refers to data representing past events or conditions associated with one or more locations, including at least stored visual information, stored positional information, and past traffic event information that have been linked over time.

The term “traffic event information” refers to data describing occurrences in a traffic environment, including at least accident events, near-miss events, or other safety-related incidents.

The term “machine learning model” refers to a computational model whose parameters are obtained by a training process on data, and that is configured to accept one or more input features and to output at least one prediction or score, such as a numerical risk index.

The term “numerical index representing a risk level” refers to a quantitative value, such as a scalar score, which expresses a likelihood or severity of occurrence of a traffic event under current or predicted conditions.

The term “staged risk level” refers to a discrete category of risk, derived from the numerical index, that represents a classification such as low, medium, or high risk according to one or more thresholds.

The term “predetermined threshold” refers to a value or set of values defined in advance or configured by a user or system administrator, used to divide a range of the numerical index into distinct staged risk levels.

The term “environmental attribute information” refers to descriptive data about a traffic environment, including at least road attributes, intersection attributes, temporal attributes, weather attributes, or other contextual parameters associated with the visual information or positional information.

The term “evaluation result information” refers to structured data generated by the processor that includes at least a computed risk level, one or more justification elements, and warning content to be presented to a vehicle operator.

The term “warning content” refers to information intended to alert a user about a risk or potentially hazardous situation, including at least recommendations, cautions, or instructions for safer behavior.

The term “generative artificial intelligence model” refers to a computational model configured to generate output data such as natural language text, given an input prompt, by learning patterns from training data.

The term “prompt sentence” refers to a text input or structured textual representation provided to the generative artificial intelligence model, the text including at least part of the evaluation result information and instructing the model to produce an appropriate output.

The term “natural language message” refers to a sequence of words or sentences in a human language, generated or selected by the system, and intended to be understandable by a human user.

The term “output data” refers to data derived from the natural language message and formatted for presentation, including at least audio data for speech output and/or graphical or textual data for visual display.

The term “warning information” refers to information communicated to a user via output data, including at least the natural language message or its equivalent, which indicates a current or upcoming risk and optionally includes recommended actions.

The term “image processing model” refers to a type of machine learning model or algorithm configured to operate on image or video data to extract features, patterns, or representations useful for subsequent analysis.

The term “statistical model” refers to an analytical model based on probabilistic or statistical methods, configured to compute one or more metrics such as the numerical risk index using input features including historical information and positional information.

The term “feature information” refers to values or representations derived from raw data, including at least numerical, categorical, or embedded representations, which are used as inputs to the machine learning model or statistical model.

The term “vehicle operator” refers to a person who controls or supervises operation of a vehicle, including a driver in a manually controlled vehicle or a user monitoring a partially or fully automated vehicle.

The term “terminal” refers to an in-vehicle or user-side computing device equipped with at least one sensor and a communication interface, configured to acquire environmental visual information and positional information and to communicate with the server.

The term “server” refers to one or more computing devices or processing nodes, including at least one processor and at least one memory, configured to perform data acquisition, storage, machine learning inference, generation of evaluation result information, and interaction with a generative artificial intelligence model.

In one embodiment, a system includes a server, one or more terminals mounted in vehicles, and one or more users who operate or supervise the vehicles. The server includes at least one processor, at least one memory, a network interface, and a non-transitory computer-readable storage medium storing instructions. The terminal includes at least one processor, at least one memory, an imaging device such as a digital camera, a positioning device such as a satellite-based positioning module, a wireless communication unit, an audio output device, and a display device. The user receives warnings and guidance generated by coordinated operation of the server and the terminal.

The server executes a program that is stored in the memory and that controls the processor to implement the functions described in the claims. The server uses general-purpose computing hardware such as a multi-core central processing unit and, in some embodiments, an accelerator such as a graphics processing unit. The server runs an operating system such as a general-purpose server operating system and uses software components such as a web application framework, a numerical computation library, and a machine learning framework. By using these components in a specific integrated pipeline, the server improves data processing throughput, risk-estimation accuracy, and the quality of natural language warnings beyond what conventional rule-based systems can achieve.

The terminal acquires environmental visual information by using the imaging device, which may be a front-facing camera mounted near a windshield or another exterior location of the vehicle. The terminal also acquires positional information by using the positioning device, which may include a receiver for satellite-based navigation signals and may be complemented by inertial sensors. The terminal converts raw sensor signals into digital data, for example by encoding images in a compressed format and representing positions as latitude and longitude values with time stamps. The terminal stores this data in a local buffer in the memory and then transmits the data to the server through the wireless communication unit using a network protocol.

The server receives the environmental visual information and positional information from the terminal through the network interface. The server associates the visual information and positional information by linking them with a common identifier such as a time stamp or a session identifier.

The server stores the associated information into a storage region that may be implemented as a database system or a structured file system. The server uses a relational or non-relational data model to store image references, positional coordinates, metadata such as vehicle identifier and speed, and derived attributes such as road segment identifiers. The server thereby creates a persistent data structure that supports efficient retrieval and aggregation of historical information aligned with spatial and temporal indices.

The server obtains historical information by retrieving past records from the storage region and from at least one traffic event data source. The server stores traffic event information, such as accident reports and near-miss reports, together with associated positional information and optional visual evidence, in a database. The server links current positional information to historical information by performing spatial indexing or map-matching operations, which may use geospatial libraries and road network data. Through this linking, the server constructs feature sets that characterize the history of traffic events in the vicinity of the current vehicle position.

The server employs a machine learning model to calculate a numerical index representing a risk level of occurrence of a traffic event. The server, in one embodiment, uses a neural network architecture that combines an image processing model with a statistical model. The image processing model may be implemented as a convolutional neural network that includes multiple convolutional layers, non-linear activation layers, pooling layers, and fully connected layers. The convolutional neural network receives preprocessed image data as input, where the server has resized and normalized the image and converted it into a tensor format suitable for computation. The convolutional neural network extracts feature information such as edge patterns, object shapes, and lane markings, and outputs a dense feature representation.

The server also uses a statistical model that processes non-image features, such as accident frequencies, distributions of accident types, road attributes, time-of-day attributes, weather attributes, and other environmental attribute information. The statistical model can be implemented as a gradient-boosted decision tree model, a logistic regression model, or another supervised learning model that operates on tabular feature vectors. The server encodes categorical features into numerical representations, normalizes continuous features, and constructs a feature vector representing the historical risk context at the current or predicted vehicle position.

The server integrates feature information obtained from the image processing model and feature information obtained from the statistical model by concatenating or otherwise combining the feature vectors into a unified representation. The server inputs the unified representation into one or more fully connected layers that output the numerical index representing the risk level. The server may use a sigmoid or softmax activation function to produce a probability-like value bounded in a particular range. During training, the server applies a loss function such as binary cross-entropy or categorical cross-entropy calculated between predicted risk values and ground-truth labels derived from past traffic events. The server updates model parameters by using an optimization algorithm such as stochastic gradient descent, an adaptive gradient method, or another weight update method, iterating over large datasets that include synchronized visual information and historical event records. The server may perform data augmentation on image data, such as random cropping, flipping, brightness adjustment, or noise injection, to improve generalization and robustness.

The server, after training is complete, deploys the trained model in an inference mode. In inference mode, the server uses precomputed model parameters stored in the memory and loads them into the processor or accelerator. The server executes forward-pass computations for each new feature set received from the terminal, generating a numerical index with low latency. By performing inference in a batched or optimized manner, the server reduces processing time and increases throughput relative to naive implementations that would compute risk on a per-rule basis.

The server converts the numerical index into a staged risk level by applying predetermined thresholds. For example, the server can define a low-risk range, a medium-risk range, and a high-risk range based on empirical analysis or regulatory guidelines. The server may store threshold values in a configuration file that can be updated without changing the core model. The server generates evaluation result information that structures the risk level, numerical index, one or more justification elements derived from feature attributions or rule-based reasoning, and warning content suggesting appropriate user actions. The justification elements can include indicators such as “high historical accident frequency within a defined radius,” “complex intersection ahead,” or “limited visibility detected in image features.” By structuring this information in a machine-readable format, the server creates data that is suitable for further algorithmic processing, including use as input to a generative artificial intelligence model.

The server generates a prompt sentence for a generative artificial intelligence model by embedding the evaluation result information into a textual representation. The server constructs the prompt sentence using a template that includes descriptive text and structured variables. In one example, the server forms a prompt sentence such as:

“The system has computed a high traffic risk level (score 0.82) for the current vehicle location. Historical accident density in this area is significantly above average, and the road environment includes a complex intersection with limited visibility. Generate a concise natural language warning message for the driver, including a brief explanation of the risk and clear guidance on safe driving behavior.”

The server then transmits the prompt sentence to the generative artificial intelligence model, which may be deployed on the same server or on a separate computing system accessible through an application programming interface. The server receives the natural language message output by the generative artificial intelligence model and stores or caches the message. The server may perform additional checks, such as length limitation or filtering of inappropriate content, before forwarding the message to the terminal.

The terminal receives the natural language message and converts it into output data. The terminal uses a text-to-speech engine to transform the natural language message into audio data and sends the audio data to the audio output device, such as loudspeakers or a headset. The terminal also displays a textual version of the message and a visual risk indicator on the display device. The user perceives the audio warning and visual display and may adjust vehicle operation, for example by reducing speed, increasing following distance, or paying closer attention to the environment.

The server and the terminal cooperate in a way that improves computer technology rather than merely automating a mental process. The server reduces communication load by predefining what data is necessary for the machine learning model and by compressing or aggregating data at the terminal. The server reduces computational overhead by integrating the image processing model and the statistical model into a unified architecture that uses shared intermediate representations, which minimizes redundant computation when processing new samples. The server further improves data management by storing associated visual, positional, and event information in a structured storage region optimized for combined spatial-temporal queries, enabling efficient retrieval of relevant historical data for real-time inference.

The server achieves higher risk-estimation accuracy compared to conventional rule-based systems because the model learns complex, non-linear relationships among visual features, road attributes, and historical event patterns that are not apparent to human designers. The server also reduces latency by using optimized numeric libraries and by preloading model parameters into fast memory. The use of batched processing and vectorized operations contributes to improved throughput, enabling the system to provide timely warnings even when handling data from many terminals. The system does not merely use a generative artificial intelligence model as a generic text generator.

The server enforces a specific protocol whereby the generative artificial intelligence model receives a constrained prompt sentence derived from structured evaluation result information, including precise risk levels and justification data. This arrangement ensures that the generative artificial intelligence model operates within a controlled context and produces messages that are technically aligned with internal risk computations. The server thereby leverages generative capabilities to improve human comprehension without relinquishing control of the underlying safety logic.

The technical effects stem from the specific combination of data structures, model architectures, and processing sequences. Because the server uses a neural network to extract high-level features from visual information, the system can identify subtle environmental cues, such as partial occlusions or complex lane markings, that would be difficult to encode in fixed rules. Because the server combines these features with statistical features derived from historical information, the system can handle scenarios where visual cues alone are insufficient but historical patterns strongly indicate risk. Because the server converts results into structured evaluation result information and into carefully designed prompt sentences, the system can generate natural language messages that both reflect internal reasoning and are adaptable to varying risk situations.

In one variation, the server uses an alternative image processing model such as a transformer-based vision model, and in another variation, the server uses an alternative statistical model such as a probabilistic graphical model capable of representing dependencies among different road attributes and event types. In some embodiments, the server executes part of the feature extraction processing on an accelerator device, while executing other parts on a general-purpose processor to balance speed and resource use. In other embodiments, the terminal performs some preprocessing, such as downscaling images or computing simple edge maps, in order to reduce network bandwidth without significantly degrading risk estimation.

The server can also implement an adaptive thresholding mechanism that adjusts the predetermined thresholds based on current traffic density or weather conditions. In this case, the server periodically recomputes threshold values using historical statistics and configuration rules, storing the updated values in the storage region and applying them without retraining the entire model. This provides a flexible mechanism to tailor risk-level classification to different operational environments, such as urban, rural, or highway settings.

The server may further maintain multiple generative artificial intelligence configurations optimized for different user groups or languages. The server selects an appropriate configuration based on terminal attributes, such as user language settings or accessibility preferences, and adjusts the prompt sentences accordingly. For instance, the server may use a prompt sentence such as: “Generate a short, simple warning for a cautious driver. The system has detected a medium risk level (score 0.55) due to moderate accident history and reduced visibility in the current area. Use clear and non-technical language.”

By structuring such prompt sentences, the server enables tailored communication, improves user understanding, and enhances safety outcomes, all while preserving the technical rigor of the underlying risk computation mechanisms.

Through these embodiments and variations, the server, the terminal, and the user interact in a coordinated manner that yields concrete technical improvements, including increased risk-assessment precision, reduced processing latency, efficient utilization of computational and communication resources, and enhanced clarity of warnings delivered to users.

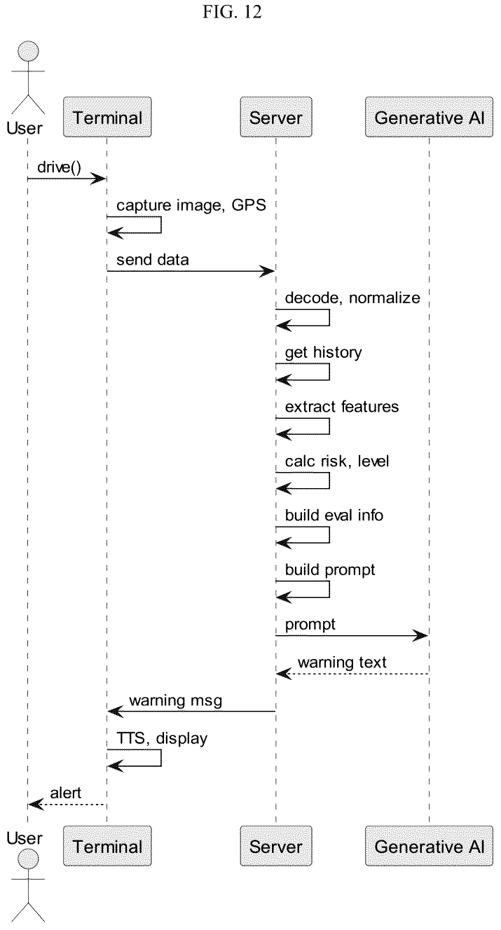

The following describes the processing flow using FIG. 12.

### Step 1:

The terminal acquires raw sensor data.

The terminal uses an imaging device to capture an image frame or a short video segment representing the environment in front of the vehicle and uses a positioning device to obtain current geographical coordinates and a time stamp.

The input to this step is the analog signal from the imaging device and positioning signal data from the positioning device.

The terminal converts the analog signals into digital data, encodes the image into a compressed format such as JPEG, and represents the positional information as numeric latitude and longitude values together with a time stamp and vehicle identifier.

The output of this step is a raw data record including compressed visual data, positional coordinates, and associated metadata stored in a local buffer.

### Step 2:

The terminal preprocesses and packages data for transmission.

The terminal downsamples or resizes the compressed image to a lower resolution if necessary, and attaches additional metadata such as vehicle speed, heading, and sensor status flags.

The input to this step is the raw data record from Step 1.

The terminal constructs a structured payload, for example a message including fields for image content, positional information, and metadata, and may compute a checksum or hash value for integrity verification.

The output of this step is a transmission-ready payload that can be sent over a wireless communication channel.

### Step 3:

The terminal transmits the structured payload to the server.

The terminal establishes a wireless connection via a communication interface and sends the payload to a predefined network address of the server using a request protocol.

The input to this step is the transmission-ready payload from Step 2.

The terminal segments the payload into network packets, adds protocol headers including authentication data, and transmits the packets through the wireless interface.

The output of this step is a stream of network packets containing the payload delivered to the server.

### Step 4:

The server receives and reconstructs the incoming data.

The server listens on a network interface for incoming requests and reconstructs the complete payload from received network packets.

The input to this step is the stream of network packets transmitted in Step 3.

The server performs protocol-level validation, verifies authentication information, and reassembles the packets into the original structured payload, storing it in a reception buffer.

The output of this step is a validated payload containing compressed visual information, positional information, and metadata available for further processing.

### Step 5:

The server decodes and normalizes the visual and positional data.

The server decodes the compressed image into a pixel array and converts the positional coordinates into an internal coordinate representation suitable for spatial processing.

The input to this step is the validated payload from Step 4.

The server applies image decoding functions to produce a multi-dimensional array of pixel values, resizes the image to a fixed input size required by a machine learning model, and normalizes pixel intensities to a predetermined numeric range. The server also parses the positional information, converting string or serialized representations into numeric latitude and longitude values with floating-point precision.

The output of this step is a normalized image tensor and a normalized positional data structure.

### Step 6:

The server associates current data with stored historical information.

The server queries one or more storage regions to retrieve historical traffic event information and previously stored sensor records for locations near the current positional coordinates.

The input to this step is the normalized positional data structure from Step 5.

The server performs a spatial lookup by comparing the current coordinates with indexed coordinates in a database, selects records within a defined distance, and aggregates statistics such as counts and severities of past traffic events.

The output of this step is a historical feature set representing contextual risk information for the current location.

### Step 7:

The server extracts feature information from the visual data.

The server applies an image processing model, such as a neural network, to transform the normalized image tensor into a compact feature representation.

The input to this step is the normalized image tensor from Step 5.

The server passes the tensor through successive computational layers including convolution, non-linear activation, and pooling, each layer performing a specific mathematical operation to emphasize spatial patterns such as edges, lane markings, or object contours.

The output of this step is a visual feature vector that encodes high-level characteristics of the observed environment.

### Step 8:

The server constructs a combined feature representation.

The server merges the visual feature vector with the historical feature set and other non-visual attributes into a unified representation.

The input to this step is the visual feature vector from Step 7 and the historical feature set from Step 6.

The server concatenates or otherwise combines the numeric elements of these feature sets into a single feature vector, applies scaling or normalization so that different feature types have compatible numeric ranges, and optionally performs dimensionality reduction or feature selection.

The output of this step is a combined feature vector suitable for risk estimation.

### Step 9:

The server calculates a numerical risk index.

The server applies a statistical or neural network-based model to the combined feature vector to compute a scalar value representing the risk level of occurrence of a traffic event.

The input to this step is the combined feature vector from Step 8.

The server feeds the vector into one or more fully connected layers or other prediction components, multiplies the vector by weight matrices, adds bias terms, applies activation functions, and produces a single risk score. The server may also compute intermediate values such as logits and confidence measures.

The output of this step is a numerical risk index associated with the current situation.

### Step 10:

The server classifies a staged risk level and derives justification elements.

The server maps the numerical risk index to a discrete risk category and identifies key contributing factors from the feature components.

The input to this step is the numerical risk index from Step 9 and the combined feature vector from Step 8.

The server compares the numerical risk index against one or more predetermined thresholds to assign a category such as low, medium, or high risk. The server analyzes the magnitudes of feature components or uses precomputed attributions to select justification elements, such as high historical event density or presence of complex road geometry.

The output of this step is a risk classification and a set of justification elements.

### Step 11:

The server generates structured evaluation result information.

The server creates a data structure that organizes the numerical risk index, staged risk level, justification elements, and intended warning content in a machine-readable format.

The input to this step is the risk classification and justification elements from Step 10.

The server constructs a record containing fields for risk score, risk category, location summary, identified risk factors, and recommended behaviors, and may encode this record in a structured form suitable for further processing.

The output of this step is evaluation result information representing the system's assessment of the current situation.

### Step 12:

The server constructs a prompt sentence for a generative AI model.

The server converts the evaluation result information into a natural language prompt sentence that instructs a generative AI model to produce a context-aware warning message.

The input to this step is the evaluation result information from Step 11.

The server fills a textual template with values from the evaluation result information, inserting the risk level, main risk factors, and desired style of the output message. The server thereby forms a coherent sentence or set of sentences that describe the current situation and provide explicit instructions for message generation.

The output of this step is a prompt sentence in natural language.

### Step 13:

The server obtains a natural language message from the generative AI model.

The server transmits the prompt sentence to the generative AI model and receives an output message in response.

The input to this step is the prompt sentence from Step 12.

The server sends the prompt sentence through an interface to the generative AI model, waits for completion of the generation process, and captures the returned text, which constitutes a proposed warning message tailored to the current risk assessment.

The output of this step is a natural language warning message.

### Step 14:

The server prepares warning output data for the terminal.

The server converts the natural language warning message into a form that can be directly used by the terminal for audio and visual presentation.

The input to this step is the natural language warning message from Step 13.

The server may encapsulate the message in a response structure, attach the staged risk level and additional display parameters, and encode the data as a compact message suitable for network transmission.

The output of this step is a response payload containing the warning message and related presentation parameters.

### Step 15:

The terminal receives the response payload and interprets the warning.

The terminal obtains the payload from the server and parses its contents for subsequent output. The input to this step is the response payload from Step 14.

The terminal decodes the message, extracts text for the warning, reads the risk level and any display instructions, and stores the data in a local memory region reserved for immediate user notifications.

The output of this step is a set of local variables or data structures containing the warning text and presentation directives.

### Step 16:

The terminal generates audio and visual alerts for the user.

The terminal uses the extracted warning text and presentation directives to produce audio output and visual display content.

The input to this step is the set of local variables or data structures from Step 15.

The terminal passes the warning text to a text-to-speech engine to synthesize an audio signal, configures the volume and playback parameters, and sends the audio signal to the audio output device. The terminal also updates the display device with a visual representation of the warning, such as risk icons, color-coded indicators, and the text of the warning message.

The output of this step is a set of perceptible alerts presented to the user.

### Step 17:

The user perceives the alerts and adjusts behavior.

The user hears the audio warning and observes the visual indicators generated by the terminal. The input to this step is the audio and visual alerts from Step 16.

The user interprets the warning content, recognizes the indicated risk level and main risk factors, and modifies driving behavior, such as reducing speed or increasing attention to the surrounding environment.

The output of this step is a change in user behavior that reflects the guidance provided by the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented techniques for analyzing traffic environments and proposing safety improvements suffer from several technical limitations in the way digital data is processed and transformed into actionable information. In many existing systems, image information and video information obtained from traffic environments are either stored as raw multimedia streams or subjected only to simple feature extraction. As a result, such systems often lack a structured and machine-usable representation of risk factors over time and space, which limits the ability of the computing system to perform consistent, high-resolution analysis across large volumes of data.

Furthermore, traditional approaches typically rely on fixed, hand-crafted rules or static models that do not scale well with the complexity of real-world scenes, such as intersections with diverse traffic patterns and occlusion conditions. These approaches often fail to systematically aggregate detected risk-related elements over temporal and spatial dimensions, making it difficult for the processor to compute reliable occurrence frequencies, severity indices, and other quantitative metrics directly from digital sensor data. Consequently, the computer cannot robustly distinguish persistent structural issues from sporadic events, leading to suboptimal utilization of computational resources and storage.

In addition, while recent developments in machine learning and generative artificial intelligence models have enabled automatic generation of natural language descriptions, existing systems typically do not integrate structured machine-perceived risk data with dynamically constructed natural language prompts in a technically coherent pipeline. That is, raw detection outputs are either manually summarized by a human operator or passed to a generative model without precise control over content, structure, or user preferences. This results in inconsistent quality of generated reports, difficulty in reproducibility of analysis, and inefficient use of processor cycles and memory, because the models may process irrelevant or poorly formatted context.

Moreover, many known systems do not provide a mechanism by which the processor can automatically adapt the generation of improvement descriptions in response to user-specific instructions, such as a desired expression style, a targeted audience, or prioritized risk categories. Without such a mechanism, any customization typically requires manual editing by the human user, which interrupts the automated pipeline, introduces subjectivity, and fails to leverage the computational capabilities of modern processors and memory subsystems.

Thus, there is a need for an improved computer-implemented technique that: (i) transforms raw environmental information into preprocessed and structured analysis result data in a manner optimized for machine learning inference; (ii) constructs, inside the processor, a generative-model-ready input sentence that encodes a machine-usable summary of structural factors; (iii) uses a generative artificial intelligence model in a controlled way to produce consistent, high-quality natural language improvement descriptions; and (iv) programmatically adapts the generation process based on user instruction information, thereby improving the overall efficiency, reproducibility, and technical performance of the computing system in identifying and describing accident-related structural factors.

The specific processing by the specific processing unit 290 of the data processing device 12 in Example 2 is realized by the following means.

The present invention provides a server comprising a processor and a storage device, the processor being configured to acquire image information and video information as environmental information together with associated location information, to store the environmental information in the storage device, to perform preprocessing on the environmental information by executing pixel value conversion, resolution conversion, reduction of noise components, temporal segmentation, and segmentation into frames as still images to generate preprocessed environmental information, to input the preprocessed environmental information to a machine learning model and to extract, as structural factors, elements with a high probability of accident occurrence from the preprocessed environmental information, to aggregate the extracted structural factors in temporal and spatial directions to generate structured analysis result data including at least one of an occurrence frequency, an occurrence position, and a severity index, to generate within the server a natural language input sentence based on the structured analysis result data and to embed explanation information summarizing the structured analysis result data in the input sentence to construct a generative input sentence, to input the generative input sentence to a generative artificial intelligence model and cause the generative artificial intelligence model to generate, in natural language, an improvement description including measures for improving safety of a traffic environment for each of the structural factors, to associate the improvement description with the structured analysis result data and output them as report information, and to acquire user instruction information specifying at least one of an expression style of the improvement description and a priority item to be emphasized and to adjust at least one of the generative input sentence and the improvement description in accordance with the user instruction information. This enables the computing system to technically improve the end-to-end processing pipeline from raw multimedia acquisition to structured risk analysis and controlled natural language generation, thereby enhancing the accuracy, consistency, and efficiency with which the processor identifies structural risk factors, manages data representations, and produces user-adapted, machine-generated safety improvement proposals.

The term “environmental information” refers to digital information representing a physical environment of a traffic area, including at least image information and video information captured by an imaging device.

The term “image information” refers to digital data representing a still image of a scene, including pixel values arranged in a two-dimensional array or comparable data structure.

The term “video information” refers to digital data representing a time sequence of images of a scene, including compressed or uncompressed moving picture data composed of a plurality of frames.

The term “location information” refers to information indicating a geographic position of a scene or an imaging device, including at least one of coordinate information, map information, and region identification information.

The term “storage medium” refers to a hardware component capable of storing digital data, including at least one of a semiconductor memory, a magnetic storage device, and an optical storage device.

The term “preprocessed environmental information” refers to environmental information that has been transformed by at least one operation including pixel value conversion, resolution conversion, noise reduction, temporal segmentation, and frame segmentation to make the information suitable for analysis by a machine learning model.

The term “pixel value conversion” refers to processing for changing numerical values representing pixels, including at least one of color space conversion, normalization, and scaling of intensity values.

The term “resolution conversion” refers to processing for changing the number of pixels in an image or frame, including at least one of upscaling and downscaling using interpolation or decimation.

The term “noise components” refers to unwanted variations in pixel values or signal values that do not correspond to actual features in the physical environment, including at least one of sensor noise and compression artifacts.

The term “temporal segmentation” refers to processing for dividing video information into segments based on time, including partitioning a continuous video sequence into predetermined time intervals.

The term “segmentation into frames” refers to processing for treating individual images within video information as separate still images, including extraction of discrete frames from a video stream.

The term “machine learning model” refers to a computational model trained using data to perform a task such as classification, detection, or regression, including at least one of an image recognition model and a time-series image recognition model.

The term “structural factors” refers to environmental conditions or configurations that are derived from environmental information by computation and that influence the likelihood of accident occurrence, including at least visibility at a traffic junction, distinction between a pedestrian region and a vehicle region, and placement of a signal display device.

The term “element with a high probability of accident occurrence” refers to a structural factor that, when present in a traffic environment, increases the risk that a traffic accident will occur, as determined by analysis of environmental information by a machine learning model.

The term “visibility at a traffic junction” refers to a degree to which a road user can visually perceive other road users, traffic control devices, and obstacles at or near an intersection or crossing.

The term “pedestrian region” refers to a portion of a traffic environment designated or used for movement of pedestrians, including at least one of sidewalks, pedestrian crossings, and pedestrian-only zones.

The term “vehicle region” refers to a portion of a traffic environment designated or used for movement or stopping of vehicles, including at least one of traffic lanes, shoulders, and parking areas.

The term “signal display device” refers to a device that provides visual or other signals to road users for traffic control purposes, including at least one of traffic lights and pedestrian crossing signals.

The term “structured analysis result data” refers to digitally encoded data representing structural factors and associated metrics arranged in a predetermined data structure, including at least one of occurrence frequency, occurrence position, and a severity index.

The term “occurrence frequency” refers to a quantitative value indicating how often a particular structural factor or event is observed in the environmental information over a specified period or dataset.

The term “occurrence position” refers to information indicating where in space a structural factor or event is observed, including at least one of coordinates in an image, coordinates in a world reference frame, and region identifiers.

The term “severity index” refers to a numerical or categorical value representing an estimated seriousness or risk level associated with a structural factor or accident-related element.

The term “natural language input sentence” refers to a sequence of characters or tokens in a human language that is generated or assembled by the system for input to a generative artificial intelligence model.

The term “explanation information” refers to textual or symbolic information that summarizes or describes structured analysis result data in a form understandable by a human or a generative artificial intelligence model.

The term “generative input sentence” refers to a natural language input sentence that includes embedded explanation information derived from structured analysis result data and that is provided as input to a generative artificial intelligence model.

The term “generative artificial intelligence model” refers to a machine learning model configured to generate new data, including natural language text, based on input data, and including at least one of a language generation model and a multimodal generation model.

The term “improvement description” refers to natural language text generated by the generative artificial intelligence model that proposes measures for improving safety of a traffic environment in view of one or more structural factors.

The term “report information” refers to data output by the system that includes at least the improvement description and the structured analysis result data in associated form, and that is suitable for presentation to a user or for storage.

The term “user instruction information” refers to information received from a user that specifies preferences or requirements for generation or presentation of an improvement description, including at least one of an expression style and a priority item to be emphasized.

The term “expression style” refers to a characteristic manner in which content is expressed in an improvement description, including at least one of level of technical detail, tone, structure, and target audience.

The term “priority item to be emphasized” refers to a category or aspect of analysis or improvement that the system is instructed to treat as more important or prominent in the improvement description, including at least one of a particular type of structural factor, a cost constraint, and a time constraint.

The server implements an embodiment of the invention by executing computer programs on a hardware platform that includes at least one processor, a main memory, a non-volatile storage device, a network interface, and optionally a graphics processing unit. The server runs on an operating system such as a general-purpose server operating system and executes software components including a multimedia processing library such as FFmpeg, a computer vision library such as OpenCV, a numerical computation library such as a tensor computation framework, and machine learning frameworks such as a deep learning library suitable for training and inference of neural networks. The server further accesses a database management system such as a relational database management system or a document-oriented database to store environmental information, structured analysis result data, and report information.

The server acquires environmental information by receiving image information and video information from imaging devices installed in traffic areas. The imaging devices may include fixed surveillance cameras mounted near intersections, roadside cameras, or aerial cameras mounted on unmanned aerial vehicles. The server receives encoded video streams through a network interface using protocols such as real-time streaming protocols or secure hypertext transfer protocols. The server decodes the encoded video using the multimedia processing library and stores the decoded frames in a storage medium as sequences of digital images, each digital image being represented as a two-dimensional array of pixel values.

The server performs preprocessing on the environmental information in order to transform raw sensor data into data structures that are suitable for efficient and accurate neural network inference.

The server uses the computer vision library to convert each frame from an input color space into a standardized color space such as a red-green-blue or blue-green-red representation and to normalize pixel values into a predetermined numeric range. The server executes resolution conversion by downscaling high-resolution frames to a lower resolution that matches the input size required by the machine learning model, thereby reducing memory consumption and computational load while preserving the structural layout of the traffic environment. The server applies noise reduction filters such as Gaussian filtering, median filtering, or bilateral filtering to suppress sensor noise and compression artifacts that could otherwise degrade model performance.

The server also performs temporal segmentation by partitioning continuous video sequences into fixed-duration segments and by assigning segment identifiers and timestamps to each group of frames. The server segments the video into frames and stores the frames in an indexed data structure, for example, by assigning each frame an integer index, a timestamp, and a reference to corresponding location information. This structured representation allows the server to access and process frames in a deterministic order and to correlate events over time and space.

The server employs a machine learning model to extract structural factors from the preprocessed environmental information. In one embodiment, the machine learning model is a deep neural network composed of a convolutional backbone for feature extraction, followed by one or more task-specific heads for object detection, semantic segmentation, and risk factor estimation. The convolutional backbone may include multiple convolutional layers with rectified linear unit activation functions, batch normalization layers, and pooling layers, organized in stages that progressively reduce spatial resolution and increase feature depth. The server initializes the model with learned weights that have been obtained by training on annotated traffic datasets.

The server uses a detection head that outputs bounding boxes, class labels, and confidence scores for objects such as vehicles, pedestrians, signal display devices, road markings, and signs. The detection head may use anchor-based or anchor-free mechanisms and may compute losses such as a combination of classification loss and localization loss during training. The server may also use a segmentation head that outputs pixel-wise class probabilities to identify pedestrian regions, vehicle regions, and other relevant regions on the road surface. In a further embodiment, the server incorporates a temporal module such as a recurrent neural network, a temporal convolutional network, or a transformer-based sequence model to capture temporal patterns such as repeated violations of stop lines or frequent near-miss situations.

The server computes additional features from the outputs of the machine learning model by evaluating geometric relationships and motion patterns. The server calculates relative distances between detected objects, overlap ratios between pedestrian regions and vehicle trajectories, angles of approach to intersections, and occlusion patterns where one object blocks the line of sight to another. The server defines structural factors as combinations of object types and spatial-temporal relationships, for example, “a pedestrian region intersecting with a vehicle region within a crosswalk area without a corresponding signal display device in the driver's primary field of view.” These structural factors are encoded as records in a data structure that includes identifiers of the relevant frames, object identifiers, geometric parameters, and a computed risk score.

The server aggregates the structural factors over temporal and spatial dimensions to generate structured analysis result data. The server groups structural factors by geo-spatial cell, such as a specific intersection or segment of roadway, and by time interval, such as peak and off-peak periods. For each group, the server computes occurrence frequencies, such as how many times a particular conflict pattern occurs per hour, and calculates severity indices based on parameters including relative speed, proximity, and number of road users involved. The server stores the structured analysis result data in a database as schema-defined records that specify, for each structural factor type, the occurrence frequency, occurrence position, severity index, and references to representative frames.

The server generates a natural language input sentence that will be provided to a generative AI model. Unlike simple free-form descriptions, the server programmatically constructs the input sentence by reading the structured analysis result data and applying a deterministic template or rule set. For example, the server concatenates textual tokens for the type of structural factor, its frequency, and its severity into a sentence such as “At intersection A, vehicles frequently encroach into the pedestrian crossing on the north side, with an estimated occurrence frequency of 15 events per hour and a high severity index due to short stopping distances.” The server aggregates such sentences for multiple structural factors and embeds them within a larger instruction text that specifies the required output format and focus areas.

The server, for instance, may construct a prompt sentence as follows:

“From the following detected risk elements at a four-leg urban intersection, generate a detailed safety analysis and a prioritized list of improvement actions. Focus on generative reasoning about why each element increases accident risk. Use clear section titles and bullet points. Detected elements: (1) Traffic signal for eastbound vehicles is partially hidden by a billboard; (2) Crosswalk markings are severely faded on the south side; (3) Pedestrians frequently step into the roadway to see oncoming traffic because of parked vehicles blocking their view.”

In another embodiment, the server may construct a prompt sentence such as:

“The following is an analysis of traffic video from an accident-prone intersection. Please identify and describe the elements with a high possibility of causing accidents, and then propose concrete improvement measures. Focus on intersection visibility, distinction between sidewalks and roadways, and positioning of traffic signals. Here are the analysis results: [summary text]. Generate a clear, structured report for city traffic planners.”

By constructing the generative input sentence based on a machine-readable structured representation, the server ensures that the generative AI model receives dense, relevant, and context-aware information, thereby reducing unnecessary token processing and improving computational efficiency within the generative model.

The server inputs the generative input sentence into a generative AI model that is implemented as a neural network, for example, a transformer-based language model. The server tokenizes the input sentence using a tokenizer associated with the model's vocabulary and converts the tokens into embedding vectors. The transformer architecture may include multiple encoder and decoder layers with multi-head self-attention and feed-forward sublayers. Each attention head computes attention weights over the token sequence, enabling the model to focus on relationships between structural factor descriptions and instructions within the prompt.

The server configures the generative AI model with decoding parameters such as maximum output length, temperature, top-k or top-p sampling thresholds, or beam width. These parameters influence the trade-off between diversity and determinism in the generated text. The server receives the generated token sequence from the model and decodes it back into a natural language string that constitutes the improvement description. The server may perform post-processing such as normalization of whitespace, removal of incomplete trailing sentences, and enforcement of required headings or bullet structures.

The server associates the improvement description with the corresponding structured analysis result data to create report information. The server builds a report object that contains, for each structural factor, a machine-readable identifier, the computed metrics, and the natural language explanation and recommendations. The server may also attach visual artifacts, such as annotated images with bounding boxes or heatmaps, by storing references to image files in the report object. The resulting report information is stored in the database and may be rendered into formats suitable for display, such as a web document or a document file.

The server further acquires user instruction information from the terminal. The terminal may present input fields or configuration sliders allowing the user to specify an expression style, such as “technical report for engineers,” “summary for policy makers,” or “non-technical explanation for the general public,” and to specify priority items, such as “focus on low-cost measures,” “prioritize pedestrian safety,” or “emphasize measures implementable within six months.” The terminal sends the user instruction information to the server over a secure communication channel.

The server uses the user instruction information to adjust either the generative input sentence or the improvement description. For example, when the user specifies a focus on low-cost measures, the server may insert additional constraints into the prompt sentence, such as “Limit the proposed measures to low-cost changes such as signage, markings, and minor signal reconfiguration.” When the user selects a non-technical style, the server may instruct the generative AI model not to use specialized technical terms and to explain concepts in plain language. In some embodiments, the server may re-run the generative AI model with a modified prompt according to the user's preferences, thereby generating an alternative improvement description.

The use of specific data structures and model architectures provides technical advantages beyond mere automation of human analysis. The server's preprocessing pipeline, which includes resolution conversion, normalization, and noise reduction, reduces the input dimensionality and variance, enabling faster inference on the machine learning model and more accurate detection under varying lighting and weather conditions. The server's aggregation of structural factors across time and space mitigates the influence of outliers and sporadic anomalies, enabling the computer to focus on persistent, structural issues and to produce stable metrics that are directly derived from sensor data.

The server's programmatic construction of generative input sentences from structured analysis result data improves the computational efficiency of the generative AI model by limiting the input to relevant, summarized content and by enforcing a consistent structure, which leads to more predictable and reusable hidden-state patterns within the transformer network. By using user instruction information to adjust the prompt content rather than relying on manual rewriting of reports, the server reduces the number of inference passes required to obtain a satisfactory report and allows the model to reuse precomputed context embeddings where appropriate.

The server improves computer technology by optimizing the end-to-end data flow from sensor acquisition to natural language generation. The system reduces communication bandwidth by allowing raw high-frame-rate video streams to be preprocessed and summarized at the edge of the system, storing only essential structural factor records and representative frames. The server's database schema for structured analysis result data allows efficient indexing and querying by location, time, and factor type, which enhances retrieval performance and supports comparative analysis across multiple intersections. The combination of convolutional feature extraction and transformer-based language generation, orchestrated through deterministic prompt construction, produces a technical effect of higher accuracy and reduced latency in generating actionable safety proposals compared with systems that rely solely on manual review or loosely structured natural language descriptions.

The terminal presents the report information to the user through a graphical user interface. The terminal may display an interactive map showing the locations of traffic problem areas, with each location linked to a detailed report. The terminal may allow the user to filter reports by severity index, occurrence frequency, or factor type. The terminal receives user input specifying preferences for future analyses and transmits these preferences back to the server, where they are incorporated into subsequent processing and prompt generation.

The user utilizes the system by reviewing the improvement descriptions and associated structural factors, but the technical improvements of the invention are realized primarily within the server's data processing and model execution pipeline. The user is not required to manually annotate video or construct textual descriptions; instead, the server automatically transforms raw environmental information into structured risk data and controlled natural language output. The described embodiments may be varied in numerous ways, such as using different neural network architectures, different feature sets, or alternative optimization techniques, so long as the server performs the core functions of preprocessing environmental information, extracting structural factors, generating structured analysis result data, constructing prompt sentences, invoking a generative AI model, and adjusting the improvement description based on user instruction information.

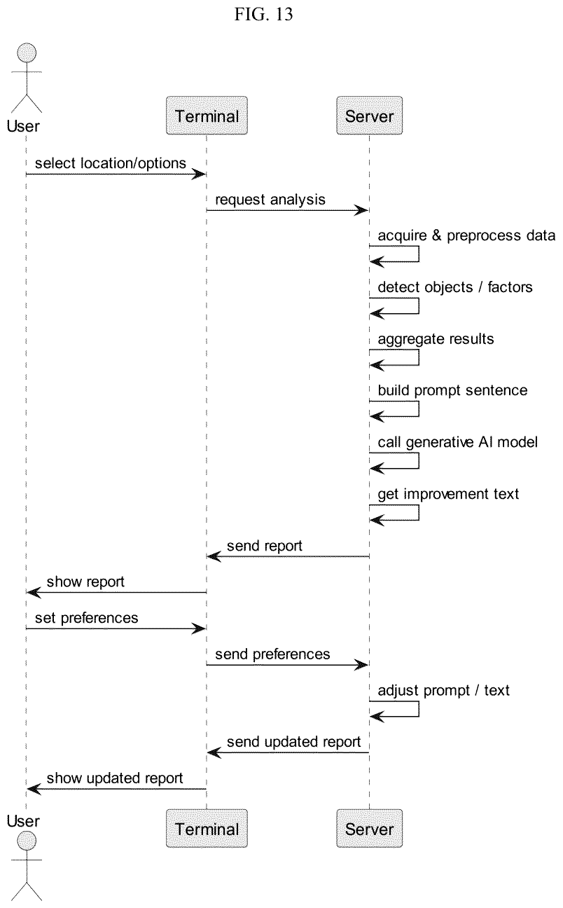

The following describes the processing flow using FIG. 13.

### Step 1:

The server acquires environmental information.

The server receives, as input, encoded video streams and still images captured by imaging devices such as surveillance cameras and aerial cameras installed around traffic areas. The server uses a network interface to establish connections via a streaming protocol or an HTTP-based protocol and authenticates to each device. The server decodes the incoming compressed data using a multimedia processing library, converting compressed bitstreams into raw frames represented as two-dimensional arrays of pixel values. The server attaches location information and timestamps received from the devices or an external positioning service to each frame. The output of Step 1 is a set of raw frames and associated metadata (location, time, device ID) stored in a storage medium.

### Step 2:

The server performs basic image preprocessing.

The server takes, as input, the raw frames and metadata produced in Step 1. The server converts each frame from the input color format into a standardized color space such as RGB or BGR using a computer vision library. The server performs resolution conversion by resizing each frame to a fixed width and height that match the input layer dimensions of a machine learning model, using interpolation algorithms to preserve geometric structure. The server executes pixel value conversion by normalizing intensity values into a predetermined numeric range, for example converting 8-bit integer values into floating-point values between 0 and 1. The server applies noise reduction filters such as Gaussian blur or median filtering to suppress random fluctuations and compression artifacts.

The output of Step 2 is a sequence of normalized, denoised, resized frames along with their metadata.

### Step 3:

The server performs temporal segmentation and frame indexing.

The server uses, as input, the preprocessed frames and metadata from Step 2. The server divides the continuous sequence of frames into temporal segments of fixed duration, for example 10 seconds or 60 seconds, based on timestamps. The server assigns a segment identifier to each group of frames and writes index records that map segment identifiers to frame indices and timestamps. The server may subsample frames at a specified rate, such as selecting one frame every N frames, to reduce redundant information. The server stores the segmented and indexed frames in a structured data container such as an array or table. The output of Step 3 is a temporally segmented and indexed frame dataset, with each segment containing a sequence of preprocessed frames and an associated segment ID.

### Step 4:

The server performs object detection and region segmentation using a machine learning model.

The server inputs, as data, batches of preprocessed frames and their segment IDs from Step 3. The server loads a trained neural network model that includes a convolutional backbone and detection and segmentation heads. The server feeds the batch tensors into the neural network, and the convolutional layers compute feature maps by applying learned filters to local pixel neighborhoods. The detection head generates bounding boxes, object class probabilities, and confidence scores for categories such as vehicles, pedestrians, signal display devices, road markings, and signs. The segmentation head produces a class label for each pixel, distinguishing pedestrian regions, vehicle regions, and background. The server filters detection results by applying confidence thresholds and non-maximum suppression to remove duplicate boxes. The output of Step 4 is a set of detected objects and segmented regions for each frame, including coordinates, class labels, and confidence scores.

### Step 5:

The server computes structural factors from detected objects and regions.

The server receives, as input, the detection and segmentation outputs from Step 4 together with the frame metadata. The server calculates geometric relationships such as distances between detected objects, overlaps between pedestrian regions and vehicle trajectories, and relative positions of signal display devices with respect to lanes and crossings. The server determines line-of-sight obstructions by analyzing which objects lie between a driver's viewpoint region and a target object such as a pedestrian crossing or signal display device. The server identifies patterns such as vehicles stopping beyond a stop line, pedestrians walking in vehicle regions, or signal display devices located outside typical gaze directions. The server encodes each such pattern as a structural factor record containing a factor type, frame ID, spatial coordinates, and a preliminary risk score. The output of Step 5 is a collection of structural factor records linked to frames and locations.

### Step 6:

The server aggregates structural factors over time and space to generate structured analysis result data.

The server uses, as input, the structural factor records from Step 5 and their associated location and time metadata. The server groups records by geographic location, such as intersection or road segment identifiers, and by time intervals such as hour of day or traffic period. Within each group, the server counts how many times each factor type occurs to compute occurrence frequencies, and calculates severity indices using functions that combine metrics such as minimal distances, relative velocities, and number of involved road users. The server determines representative frames for each factor type by selecting samples with the highest severity indices. The server stores the aggregated values and references in a structured data format such as a table or JSON-like object, with fields including factor type, occurrence frequency, occurrence position, severity index, and representative frame IDs. The output of Step 6 is structured analysis result data for each location and factor type.

### Step 7:

The server constructs a prompt sentence for a generative AI model.

The server inputs, as data, the structured analysis result data from Step 6. The server generates natural language clauses based on each structural factor type, inserting numeric values such as frequencies and severity indices into template sentences. The server concatenates these clauses into a coherent summary that describes the current traffic environment risks. The server then wraps the summary with instruction text that specifies the desired output format, focus areas, and level of detail for the generative AI model. For example, the server may construct a prompt sentence such as: “The following is an analysis of traffic video from an accident-prone intersection. Please identify and describe the elements with a high possibility of causing accidents, and then propose concrete improvement measures. Focus on intersection visibility, distinction between sidewalks and roadways, and positioning of traffic signals. Here are the analysis results: [summary text]. Generate a clear, structured report for city traffic planners.”

The output of Step 7 is a fully constructed prompt sentence that incorporates the structured analysis result data.

### Step 8:

The server invokes the generative AI model to generate an improvement description.

The server uses, as input, the prompt sentence constructed in Step 7. The server tokenizes the prompt sentence using a tokenizer compatible with a transformer-based generative AI model and converts the tokens into embedding vectors. The server passes the embedding sequence through multiple layers of the generative AI model, where self-attention mechanisms compute context-aware representations for each token and feed-forward sublayers transform these representations into higher-level features. The server applies a decoding strategy, such as greedy decoding or sampling-based decoding, to generate output tokens that form a natural language improvement description.

The server converts the output tokens back into a text string and may perform minor post-processing to ensure well-formed sentences and desired formatting. The output of Step 8 is an improvement description text that proposes measures for improving traffic safety for the identified structural factors.

### Step 9:

The server adjusts the improvement description based on user instruction information.

The server receives, as input, user instruction information transmitted by the terminal, including preferences such as expression style and priority items. The server analyzes the user instruction information and decides whether to modify the existing improvement description or to reconstruct a new prompt sentence. If reconstruction is required, the server augments the original prompt sentence with additional constraints, for example adding phrases such as “Use non-technical language suitable for the general public” or “Limit recommendations to low-cost measures implementable within six months.” The server optionally re-invokes the generative AI model with the modified prompt to generate an updated improvement description. Alternatively, the server may post-process the existing text to adjust terminology or structure. The output of Step 9 is a user-tailored improvement description that reflects the specified preferences.

### Step 10:

The server assembles and stores report information.

The server uses, as input, the structured analysis result data from Step 6 and the improvement description from Step 8 or Step 9. The server creates a report object that links each structural factor with its computed metrics and the corresponding section of narrative explanation and recommendations. The server may generate additional visual aids, such as references to annotated frames, and include these references within the report object. The server writes the report object into a database or file system with an identifier that associates the report with a specific location and time period. The output of Step 10 is stored report information ready to be delivered to the terminal.

### Step 11:

The terminal requests and displays the report information.

The terminal receives, as input, user selections such as a target intersection, date range, or severity threshold. The terminal sends a request containing these parameters to the server over a secure network connection. The terminal then receives the report information or a reference to it from the server. The terminal parses the report information and renders it on a display, for example by showing a map view with highlighted locations and a detailed textual report including the improvement description and key metrics. The output of Step 11 is a visual and textual presentation of the report information on the terminal's screen.

### Step 12:

The user reviews the report and optionally updates preferences.

The user views, as input, the displayed report information on the terminal. The user interprets the improvement description and associated structural factors and may decide to refine preferences regarding expression style or focus topics, such as emphasizing pedestrian safety or cost constraints. The user enters updated preferences into the terminal, which sends them as new user instruction information to the server. The output of Step 12 is updated user instruction information that can be used in subsequent executions of Steps 7 to 9 to further tailor future reports.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional traffic-safety support systems, even when using digital maps or simple rule-based analytics, generally treat accident statistics, infrastructure conditions, and user experience as separate, weakly coupled data streams. A typical system statically marks accident-prone areas based on historical counts and may display these areas on a map or adjust route planning using fixed heuristics. Such systems suffer from several technical limitations.

First, existing computing architectures do not integrate heterogeneous sensor data streams (visual information, time-series information, positioning information, and traffic information) into a unified machine-interpretable representation that can be efficiently exploited by advanced models. Visual data from cameras and temporal traffic logs are often processed in isolation, which prevents the processor from learning fine-grained structural problems such as intersection visibility degradation, ambiguous lane separation, or inadequate placement of traffic control indicators under varying environmental conditions.

Second, conventional machine learning pipelines in this domain are typically closed and static: they detect patterns or classify risks but do not dynamically generate or refine countermeasures at the system level. As a result, they cannot automatically synthesize detailed, context-aware improvement proposals for infrastructure or operational policies, and they cannot respond flexibly as new patterns or combinations of risk emerge.

Third, user emotion and perceived safety are rarely integrated as primary computational signals in the core decision logic. Known systems might log user feedback as free text or simple ratings, but they do not continuously capture multimodal emotion signals (expression, voice, biological reaction), associate these signals with position and structural problems, or use these signals as weighted factors in risk evaluation and prioritization. Consequently, the processor is unable to compute an emotion-based weighted priority that reflects both objective accident risk and subjective user experience.

Fourth, generative artificial intelligence models are not systematically embedded into the traffic-analysis and route-optimization loop. Without a structured prompt-generation mechanism that encodes structural problems, traffic statistics, and emotion-weighted priorities into a coherent prompt sentence, calls to generative AI models can be ad hoc, non-repeatable, and difficult to align with system constraints. This leads to inconsistent output quality, limited traceability, and poor integration of generated improvement plans into downstream control logic.

Fifth, route optimization in existing systems is often based purely on travel-time minimization with coarse avoidance of static danger zones. There is no algorithmic connection between dynamically generated, prioritized improvement plans and the computation of evaluation values for candidate routes. Thus, route-search algorithms cannot systematically incorporate newly generated structural improvements, updated risk indices, or real-time emotional responses into the selection of an operation route for a moving body.

Sixth, most systems lack a closed feedback loop in which user evaluation and feedback are used to update not only user-interface aspects but also core analytic components such as emotion-analysis conditions, risk-index calculation conditions, and prompt-generation conditions. Without such a loop, the system cannot self-adjust its models and prompt sentences over time, and cannot continuously improve the relevance and effectiveness of both the generated improvement plans and the resulting route optimization.

Accordingly, there is a need for an improved computer-implemented system that (i) unifies multimodal traffic and user data into a consistent representation, (ii) automatically detects structural problems using machine learning, (iii) computes risk indices and emotion-based weighted priorities, (iv) generates structured prompt sentences for a generative AI model, (v) parses and ranks the AI-generated improvement plans, (vi) integrates these plans into route optimization for moving bodies, and (vii) updates its analytic and prompt-generation behavior based on ongoing user evaluation and feedback. Such a system should improve the technical operation of computers used for traffic safety by enabling more accurate, adaptive, and user-aware processing pipelines, rather than merely presenting pre-computed static information to a human operator.

The specific processing by the specific processing unit 290 of the data processing device 12 in Application Example 2 is realized by the following means.

The present invention provides a server comprising a processor configured to acquire and store position-added visual and time-series information from accident-prone and non-accident-prone areas, to preprocess and analyze the stored information using a machine learning algorithm so as to specify structural problems, to acquire and analyze traffic information in order to calculate a risk index and a priority index associated with the structural problems, to estimate an emotional state of a user from multimodal emotion-related information and to calculate an emotion-based weighted priority for each structural problem, to organize information regarding the structural problems, the traffic information, and the emotion-based weighted priority and to generate a prompt sentence including the organized information, to input the prompt sentence into a generative artificial intelligence model and obtain from the generative artificial intelligence model a response including an improvement proposal, to structure and rank improvement-plan information derived from the response based on the risk index and the emotion-based weighted priority, to calculate an evaluation value for a route of a moving body based on the ranked improvement-plan information and the risk index and to optimize an operation route of the moving body by using a route-search algorithm, and to acquire evaluation information and feedback information from the user and update at least an analysis condition of an emotion analysis engine, a calculation condition of the risk index, and a generation condition of the prompt sentence so as to regenerate the prompt sentence for the generative artificial intelligence model. This enables a computer system to perform integrated, feedback-driven processing of heterogeneous traffic and emotion data, to automatically generate and prioritize context-aware improvement plans by coordinated use of discriminative and generative models, and to dynamically adapt route computation and prompt-generation behavior in response to evolving structural conditions and user-perceived risk, thereby improving the technical performance and adaptability of traffic-safety computing systems.

The term “visual information” refers to data representing a scene in a traffic region that is captured by an imaging device and expressed as still-image or video-format digital data.

The term “time-series information” refers to data that changes over time and is recorded as a sequence of values or events with associated timestamps, including sensor readings, traffic measurements, and temporally ordered image or video frames.

The term “accident-prone area” refers to a spatial region in a traffic environment in which a frequency or probability of traffic accidents exceeds a predetermined threshold relative to other regions.

The term “non-accident-prone area” refers to a spatial region in a traffic environment in which a frequency or probability of traffic accidents is below a predetermined threshold and is relatively lower than that of an accident-prone area.

The term “traffic region” refers to a physical environment used for movement of vehicles or pedestrians, including at least one of roads, intersections, lanes, sidewalks, and related traffic infrastructure.

The term “position information” refers to data indicating a geographic location of an object or event, including at least one of coordinates in a positioning system, such as latitude and longitude, and identifiers associated with map segments.

The term “storage device” refers to a hardware or logical component configured to store digital data, including at least one of a semiconductor memory, a magnetic storage device, an optical storage device, and a database system.

The term “machine learning algorithm” refers to a computational procedure that adjusts internal parameters based on training data to perform tasks such as classification, regression, clustering, or prediction on new data without being explicitly programmed for each specific case.

The term “structural problem” refers to a physical or configuration-related deficiency in a traffic region, including at least one of poor visibility at an intersection, unclear separation between traffic lanes, inadequate placement of traffic control indicators, and inappropriate control of signaling devices, that increases accident risk.

The term “traffic information” refers to data describing dynamic and static conditions in a traffic region, including at least one of traffic-flow information, traffic-volume information, and accident-history information.

The term “traffic-flow information” refers to data describing movement of vehicles or pedestrians over time in a traffic region, including at least one of speed distributions, flow directions, and congestion states.

The term “traffic-volume information” refers to data indicating an amount of vehicles or pedestrians passing through a specified location or segment in a traffic region during a given time interval.

The term “accident-history information” refers to data describing past occurrences of traffic accidents, including at least one of accident locations, times, types, and causal factors.

The term “statistical processing” refers to computation applied to data using statistical methods, including at least one of aggregation, distribution analysis, correlation analysis, and significance testing.

The term “clustering processing” refers to a data analysis process that groups data points into clusters such that data points within a cluster are more similar to each other than to data points in other clusters based on one or more similarity measures.

The term “risk index” refers to a numerical or categorical value computed for a location or condition that represents an estimated level of traffic accident risk based on structural problems, traffic information, or both.

The term “priority index” refers to a numerical or categorical value indicating an order in which locations or problems should be addressed, calculated based on at least one of the risk index, resource constraints, and operational considerations.

The term “emotion analysis engine” refers to a software and/or hardware component configured to infer an emotional state of a user by processing emotion-related input data, such as expression information, voice information, and biological-reaction information.

The term “expression information” refers to data representing facial or bodily expressions of a user, obtained from an imaging sensor and used to infer emotional state.

The term “voice information” refers to acoustic data representing speech or vocal sounds produced by a user, including at least one of waveform samples, spectral features, and prosodic features.

The term “biological-reaction information” refers to physiological data associated with a user, including at least one of heart rate, skin conductance, respiration rate, and muscle activity, that can be used to estimate emotion.

The term “emotion-event information” refers to data that associates an estimated emotional state of a user with corresponding position information, time, and context, and represents an occurrence of a specific emotion at a specified location and time.

The term “emotion-based weighted priority” refers to a value for a structural problem that is calculated based on both objective risk information and aggregated emotion-event information, and that increases or decreases priority according to intensity or frequency of user emotions such as anxiety or fear.

The term “organized information” refers to information that has been transformed from raw data into a structured representation or natural-language description in which related items are grouped and labeled according to predefined categories.

The term “prompt sentence” refers to a text string that includes organized information regarding structural problems, traffic information, and emotion-based weighted priorities, and that is provided as an input instruction to a generative artificial intelligence model to request generation of an output.

The term “generative artificial intelligence model” refers to a trained computational model that receives an input, such as a prompt sentence, and outputs generated data, including at least one of natural-language text, structured suggestions, or recommended actions, based on learned patterns.

The term “improvement proposal” refers to content generated by the generative artificial intelligence model that suggests one or more measures intended to mitigate or resolve a structural problem in a traffic region.

The term “improvement-plan information” refers to structured data derived from an improvement proposal that includes at least an improvement-target type, countermeasure content, expected effect, and application condition.

The term “improvement-target type” refers to a classification label that specifies a category of infrastructure or operation to which an improvement-plan information item is directed, including at least one of lighting, signage, road geometry, and signal control.

The term “countermeasure content” refers to a description of an action or modification proposed to reduce a structural problem or associated risk.

The term “expected effect” refers to an anticipated outcome or benefit of implementing a countermeasure, including at least one of reduction in accident frequency, reduction in user anxiety, and improvement in visibility.

The term “application condition” refers to a constraint or prerequisite under which a countermeasure is intended to be applied, including at least one of temporal conditions, environmental conditions, or regulatory conditions.

The term “moving body” refers to a physical object that travels within a traffic region, including at least one of a vehicle, a robot, and a mobile machine.

The term “route-search algorithm” refers to a computational procedure that calculates one or more candidate paths between two or more points and selects a path based on evaluation values assigned to route segments.

The term “evaluation value for a route” refers to a computed value for a candidate route that reflects one or more criteria, including at least travel cost, risk index, and influence of improvement-plan information, and that is used to compare candidate routes.

The term “operation route” refers to a sequence of positions or segments along which a moving body is planned or instructed to move within a traffic region.

The term “warning information” refers to data representing a notification to be presented to a user or a control system about a potential hazard or increased risk along an operation route.

The term “evaluation information” refers to data indicating an assessment by a user of at least one of perceived safety, usefulness, or feasibility of a presented improvement plan or route.

The term “feedback information” refers to additional information provided by a user, including at least one of comments, ratings, and selections, that expresses a reaction to system outputs and is used to adjust system behavior.

The term “analysis condition of an emotion analysis engine” refers to one or more parameters or rules that control how the emotion analysis engine processes emotion-related input data and outputs an estimated emotional state.

The term “calculation condition of the risk index” refers to one or more parameters, weights, thresholds, or formulas used to compute the risk index from structural problems and traffic information.

The term “generation condition of the prompt sentence” refers to one or more rules, templates, or parameter settings that determine how organized information is transformed into a prompt sentence for the generative artificial intelligence model.

In one embodiment, a system includes a server and at least one terminal communicatively coupled to each other over a network. The server includes at least one processor, a main memory, and a non-volatile storage device such as a database system. The terminal includes at least one processor, a memory, an imaging device, an audio input device, an optional biological sensor, a positioning device, and a display and audio output device.

The server executes software modules implemented, for example, in a high-level programming language using numerical and machine learning libraries. The server runs an operating system and a database management system, and the server stores visual information, time-series information, positioning information, traffic information, emotion-event information, and improvement-plan information in structured tables or collections. The server uses image processing software such as an image-processing library, numerical analysis software such as a numerical-computation library, and machine learning frameworks such as a tensor-based framework or a general-purpose machine learning framework to implement the functions described below.

The terminal acquires visual information from an in-vehicle camera or similar imaging sensor and acquires voice information from a microphone. The terminal can also acquire biological-reaction information from sensors such as a heart-rate sensor or a skin-conductance sensor. The terminal acquires position information from a positioning module and associates timestamps with all acquired sensor data. The terminal stores raw data in local memory for a limited time and then transmits position-added and time-stamped data to the server via a communication protocol such as a secure transport protocol. The terminal uses a user interface framework to present graphical information on a display and to output audio messages via speakers.

The server acquires and stores position-added visual and time-series information by receiving visual data streams (for example, sequences of image frames) from the terminal along with associated positioning information and timestamps. The server inserts the received data into a database, for example, into a “visual_data” table having fields including at least: record_id, timestamp, latitude, longitude, orientation, frame_reference, and sensor_type. The server also stores raw or compressed frame data in a file system or object storage and stores references to the file locations in the database. By maintaining a normalized relational structure and indexing the position and time fields, the server improves query performance and reduces computational overhead when performing spatial and temporal joins during later analysis.

The server performs preprocessing of the stored visual and time-series information by reading batches of frames and associated metadata from the storage device. The server uses an image-processing library to decode compressed frames, convert color spaces, normalize pixel intensities, and resize the frames to predetermined dimensions suitable for input to a convolutional neural network. The server applies spatial filters such as Gaussian blurs and edge enhancement filters to reduce noise and emphasize lane markings, traffic control indicators, and object boundaries. The server augments the data by applying transformations such as rotations, flips, brightness shifts, and perspective changes to simulate different environmental conditions. This data augmentation increases the variety of training and inference inputs and reduces overfitting, thereby improving the robustness of the model to variations in weather, lighting, and camera angle.

The server uses a machine learning algorithm to analyze the preprocessed information and specify structural problems. In one embodiment, the server executes a convolutional neural network having a plurality of convolutional layers, pooling layers, and fully connected layers. The server defines an input tensor of fixed height, width, and channel count, corresponding to a preprocessed image frame.

The server processes the input tensor through convolutional layers with learned kernels to extract low-level and mid-level features such as edges, corners, lane boundaries, and shapes of traffic indicators. The server uses pooling layers to reduce spatial resolution while retaining salient features, thereby decreasing computation and memory usage. The server maps the final feature representation to output units corresponding to structural-problem categories, such as “poor intersection visibility,” “unclear lane separation,” “missing or inadequately visible traffic control indicator,” and “inappropriate signal control pattern.”

The server trains the convolutional neural network using a labeled dataset containing image frames annotated with structural-problem labels. The server defines a loss function such as cross-entropy loss between the predicted category distribution and the ground-truth label. The server updates weights in the network using an optimization method such as stochastic gradient descent or an adaptive learning-rate algorithm. The server iteratively performs forward propagation to compute predictions and backward propagation to compute gradients and adjust weights until the validation accuracy reaches a target value or until a maximum number of epochs is reached. By training this network, the server obtains a discriminative model capable of detecting multiple types of structural problems based on visual patterns that may be difficult for a human operator to quantify consistently.

The server applies the trained convolutional neural network during inference to frames acquired from accident-prone and non-accident-prone areas. The server outputs, for each frame, a probability distribution over structural-problem categories and a confidence score for each category. The server associates each detection with a position and time derived from the underlying metadata and stores the detections in a “structural_issues” table, including fields such as issue_id, category, confidence, latitude, longitude, timestamp, and related_frame_reference. The server may also generate bounding boxes or segmentation masks for the identified features and store them as structured coordinates or masks, thereby allowing more precise localization of problems such as poorly visible crosswalks or obstructed sight lines.

The server acquires and analyzes traffic information by connecting to external traffic management systems or by collecting sensor data from roadside detectors and vehicles. The server obtains traffic-flow information, traffic-volume information, and accident-history information in structured formats such as CSV or JSON. The server loads these records into a “traffic_data” table and performs statistical processing and clustering processing. For example, the server computes, for each road segment and time interval, average speed, variance of speed, count of vehicles, and accident occurrence count. The server applies clustering algorithms, such as k-means clustering or density-based clustering, to group segments that share similar patterns of traffic congestion and accident occurrences. The server calculates a risk index for each segment by combining metrics such as accident rate per unit of traffic volume, presence of structural issues, and environmental conditions. The server calculates a priority index by further considering resource constraints and operational policies. These indices are stored in a “risk_priority” table.

The terminal acquires emotion-related input when a vehicle or other moving body travels through the traffic region. The terminal runs an emotion-capture module that activates the imaging device and audio input device while the moving body is within predetermined distance thresholds of segments labeled by the server as accident-prone or structurally problematic. The terminal records facial image sequences of the user and captures voice signals when the user speaks. The terminal optionally records biological-reaction information such as heart-rate variability or skin conductance via connected sensors. The terminal associates each captured sample with a timestamp and position information and then applies local preprocessing.

The terminal uses an image-processing library to detect a face region and facial landmarks such as the positions of eyes, eyebrows, mouth, and nose in each frame. The terminal computes expression descriptors such as degree of eye opening, angle of mouth corners, and movement of eyebrows over time. The terminal uses a voice-processing library to compute features such as fundamental frequency, energy, spectral envelope, and speech rate from the recorded voice signal. The terminal normalizes these features and compiles them into a feature vector representing a short time window of the user's behavior.

The server receives these feature vectors from the terminal or, in an alternative embodiment, the terminal executes the following emotion analysis locally and only sends classification results to the server. The server executes an emotion analysis engine implemented as a multimodal neural network. For example, the server uses a network architecture that includes a convolutional subnetwork for image-derived features and a recurrent or transformer-based subnetwork for temporal voice features, followed by a fusion layer that concatenates or attends over both modalities. The server trains this network using labeled emotion datasets where ground-truth emotion states such as “calm,” “slightly anxious,” “highly anxious,” and “fearful” are recorded alongside corresponding feature vectors. The server defines a loss function such as categorical cross-entropy and an optional regularization term to encourage smoothness over time. The server performs backpropagation and weight updates using an optimization algorithm until classification performance stabilizes.

The server applies the trained emotion analysis engine to incoming feature vectors and outputs an estimated emotion category and a probability distribution over possible categories. The server associates each emotion classification with position information and timestamps, storing the results as emotion-event information in an “emotion_events” table. For example, the server stores fields such as event_id, latitude, longitude, timestamp, emotion_category, emotion_confidence, and reference_to_segment. By indexing emotion-events by location and time, the server can efficiently aggregate emotional responses across many users at the same physical site or during similar environmental conditions.

The server calculates an emotion-based weighted priority by combining the objective risk index and the aggregated emotion events. For each structural problem and associated segment, the server retrieves the risk index and counts or weights emotion-events according to severity (for example, assigning a higher weight to fear than to slight anxiety). The server computes a composite score, such as a weighted sum or a non-linear combination, to yield an emotion-based weighted priority.

The server stores this value in the “risk_priority” table. This combination allows the system to emphasize locations where objective data indicates high risk and where users frequently experience negative emotions, thereby aligning system behavior with both engineering metrics and user-perceived safety.

The server organizes information regarding the structural problems, the traffic information, and the emotion-based weighted priority to generate a prompt sentence for a generative AI model. The server uses a prompt-construction module that retrieves, for a given location or group of locations, the list of structural problems, their spatial extent, the associated risk indices, traffic patterns (for example, high accident frequency at night under wet conditions), and aggregated emotion scores. The server formats this information into a natural-language description according to a template. For example, the server may generate a prompt sentence as follows:

“Given the following situation: At intersection A, visibility is poor due to sharp curves and roadside obstacles, lane markings are faded, and users frequently report strong anxiety when passing through. Nighttime accident frequency is high, especially in rainy conditions. Please propose detailed engineering and operational improvement measures to reduce accident risk. Include recommendations on traffic light placement, road geometry modification, lighting upgrades, signage, and lane markings, and explain why each measure is effective.”

In another example, when previously suggested measures have not produced sufficient improvement, the server may generate a refined prompt sentence:

“Previous improvement measures at intersection B (additional lighting and repainted crosswalks) have not fully reduced user anxiety; many users still report feeling unsafe at night and complain that approaching vehicles are hard to notice. Considering this history and the current traffic data, please propose alternative or supplementary improvement measures, such as physical speed-reduction devices, improved sight lines, or revised signal timings, and justify each recommendation.” The server inputs the prompt sentence into a generative AI model via an application programming interface. The generative AI model is, for example, a large-scale neural network language model trained on a wide range of text data and fine-tuned for instruction-following behavior. Internally, such a model comprises multiple layers of self-attention and feedforward components, processes tokenized representations of the prompt, and outputs token sequences corresponding to natural-language text. The server controls parameters such as maximum output length, sampling temperature, and nucleus sampling threshold to adjust diversity and determinism of the generated text.

The server receives the output text from the generative AI model and parses it into structured improvement-plan information. The server uses natural-language processing techniques, such as pattern-based extraction and named-entity recognition, to segment the text into distinct proposals. For each proposal, the server identifies an improvement-target type (for example, lighting, signage, road geometry, signal control), extracts countermeasure content (for example, “install additional overhead luminaires at 30-meter intervals”), identifies expected effect (for example, “improve driver detection of pedestrians at crosswalks by increasing horizontal illuminance”), and determines application conditions (for example, “apply during nighttime for speed limits above a threshold”).

The server stores these structured proposals in an “improvement_plans” table, linking them to specific segments and structural problems.

The server ranks the improvement-plan information based on the risk index and emotion-based weighted priority. The server computes a scoring function for each proposal that incorporates the seriousness of the associated structural problem, the segment's risk index, and the aggregated emotion-based priority. In one embodiment, the server also considers implementation complexity or cost as an additional parameter. The server sorts proposals by the resulting score and marks the top-ranked proposals as high-priority for implementation and for route planning. This computation allows the server to apply a consistent, algorithmic prioritization strategy that is more complex and data-driven than a simple human ranking or a fixed rule set.

The server uses the ranked improvement-plan information and the risk index to calculate an evaluation value for candidate routes of a moving body. The server represents the traffic region as a graph where nodes correspond to intersections or key points and edges correspond to road segments.

The server assigns each edge a base travel cost (for example, time or distance) and a risk-related cost derived from the risk index and from whether the segment intersects known structural problems or high-priority improvement locations. The server modifies risk-related costs dynamically according to emotion-based weighted priorities, increasing the cost of segments that cause strong user anxiety.

The server then executes a route-search algorithm, such as Dijkstra's algorithm or an A* search algorithm with a heuristic that estimates remaining travel cost, to find an operation route that minimizes a combined cost function. The server thereby generates an optimized operation route that balances travel efficiency with safety and user comfort.

The server outputs the optimized operation route and associated warning information to the terminal and, optionally, to a vehicle control system. The server encodes the route as a sequence of waypoints or segments with associated instructions such as desired speeds or lane preferences. The server generates warning messages in natural language for segments that contain residual risks, for example, “Upcoming intersection has limited sight distance; system will reduce speed.” The terminal displays the route on a map view and highlights dangerous segments in a distinct color and overlays text or icons indicating structural problems. The terminal also plays audio warnings through its speaker so that the user is informed of upcoming hazards even without looking at the display.

The user observes the presented route and warnings and may provide evaluation information and feedback information. The user interacts with the terminal's user interface by selecting buttons, entering comments, or issuing voice commands. For example, the user may indicate that a certain segment still feels unsafe, or that an implemented improvement has substantially increased perceived safety. The terminal packages this evaluation and feedback information with contextual data such as location, time, selected route, and recent emotion-events and transmits it to the server.

The server stores user evaluation and feedback in a “user_feedback” table and periodically analyzes it. The server computes statistics such as frequency of negative feedback per segment, correlation between feedback and emotion-event frequencies, and consistency between predicted risk indices and perceived risk. Based on these analyses, the server adjusts the analysis conditions of the emotion analysis engine, such as sensitivity thresholds or class boundaries; adjusts the calculation conditions of the risk index, such as weights assigned to structural issues or traffic metrics; and adjusts the generation conditions of the prompt sentence, such as which attributes are emphasized in the prompt and how constraints are described. The server then regenerates future prompt sentences using the updated conditions, thus closing a feedback loop that continuously refines both discriminative and generative components of the system.

By implementing these modules and data flows, the server and terminal cooperate to perform processing that is not a mere automation of human mental activity. The server processes high-volume, high-dimensional sensory data in real time, using optimized data structures and learned models to detect patterns that are not directly observable through simple aggregation. The use of convolutional neural networks and multimodal emotion networks with specific architectures, training procedures, and loss functions yields improved detection accuracy and robustness compared to rule-based systems. The structured prompt-generation mechanism converts internal states and indices into precise prompt sentences for a generative AI model, improving consistency, repeatability, and traceability of generated improvement proposals. The integration of improvement plans into a graph-based route-search algorithm with a multi-criteria cost function improves computational efficiency and route quality by enabling the algorithm to prune routes that are objectively risky or emotionally undesirable, thereby reducing the search space.

In alternative embodiments, the server may use different types of neural network architectures, such as residual networks, attention-based networks, or graph neural networks, for structural-problem detection or emotion analysis. The server may execute these models on specialized hardware such as graphics processing units or tensor accelerators, thereby achieving higher throughput and lower latency in environments with many simultaneous users or dense sensor networks. In other variants, the terminal may execute some models locally, sending only compressed intermediate representations to the server to reduce communication bandwidth, while the server performs fusion and global optimization. These variations still use the same core concepts of position-added multimodal data acquisition, machine-learning-based structural and emotional analysis, generative-AI-based improvement planning, and risk- and emotion-aware route optimization.

Through these concrete hardware and software configurations, specific data structures, and defined learning and inference procedures, the system improves the technical operation of computers in the traffic-safety domain by increasing detection precision, reducing processing time for complex route evaluations, improving data management for multimodal streams, and enabling adaptive, feedback-driven behavior that cannot be achieved by conventional static or purely rule-based approaches.

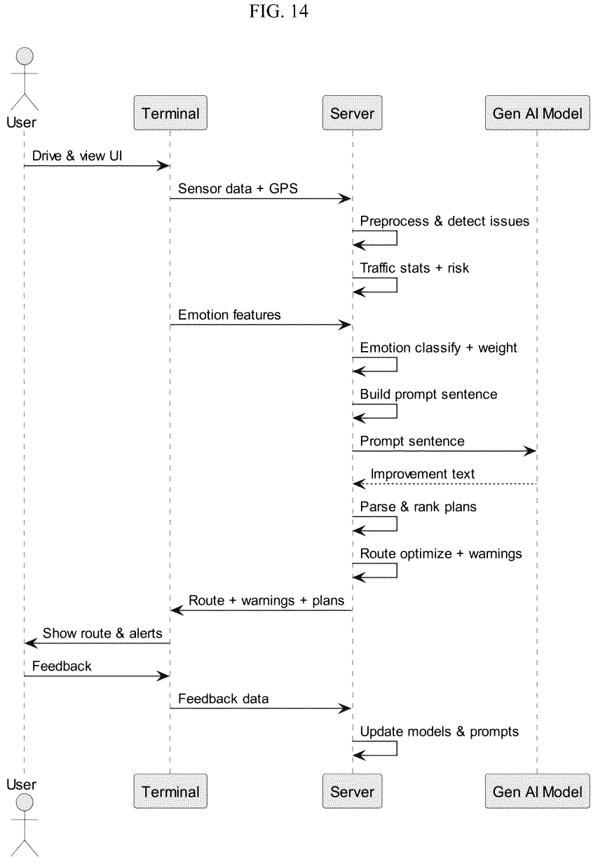

The following describes the processing flow using FIG. 14.

### Step 1:

Server acquires and stores position-added visual and time-series information.

Server receives, as input, visual information and time-series information transmitted from the terminal, including image frames or video segments, timestamps, and raw position information.

Server performs data processing by validating message integrity, decoding any compressed payloads, and normalizing coordinate formats. Server writes, as output, position-added and time-stamped records into a storage device, for example into a visual_data table that stores fields such as record_id, timestamp, latitude, longitude, orientation, frame_reference, and sensor_type, and stores the corresponding image files in a file system or object storage.

### Step 2:

Terminal acquires multimodal sensor data in the vehicle.

Terminal receives, as input, raw signals from an imaging device, an audio input device, an optional biological sensor, and a positioning device. Terminal performs data processing by sampling the signals at predefined rates, synchronizing the sensor streams using timestamps from a common clock, and temporarily buffering the sampled data in local memory. Terminal generates, as output, synchronized sensor packets that each include a set of image frames, audio samples, biological-reaction samples, and associated position information for a short time window.

### Step 3:

Terminal attaches position and time metadata and transmits sensor packets.

Terminal receives, as input, the synchronized sensor packets from local buffers. Terminal performs data processing by converting raw position readings into standardized coordinates, embedding latitude, longitude, and timestamps into metadata structures of the image and audio data, and compressing large payloads using a predetermined codec. Terminal outputs position-tagged sensor packets and transmits them to the server via a secure communication protocol, thus providing the server with multimodal time-series data aligned with geographic positions.

### Step 4:

Server preprocesses visual information for machine-learning analysis.

Server receives, as input, position-tagged visual data records from the visual_data table and corresponding image files from storage. Server performs data processing by decoding image files, converting color spaces to a target format, resizing images to a fixed resolution suitable for a convolutional neural network, normalizing pixel values, and applying noise-reduction and edge-enhancement filters using an image-processing library. Server outputs preprocessed image tensors and stores references to these tensors in an intermediate_preprocess table together with their associated record_id, timestamp, and position information.

### Step 5:

Server detects structural problems using a convolutional neural network.

Server receives, as input, the preprocessed image tensors and their metadata from the intermediate_preprocess table. Server performs data computation by feeding each tensor through a trained convolutional neural network, performing convolution, pooling, and fully connected operations to compute feature maps and final output probabilities over structural-problem categories. Server applies a thresholding and non-maximum suppression procedure to determine which problems are present in each frame. Server outputs a set of detections that include category labels, confidence scores, and bounding regions, and writes these detections to a structural issues table with fields including issue_id, category, confidence, latitude, longitude, timestamp, and frame_reference.

### Step 6:

Server acquires and aggregates traffic information.

Server receives, as input, traffic-flow records, traffic-volume records, and accident-history records from external systems or from stored traffic logs. Server performs data processing by loading the records into memory, cleaning missing or inconsistent values, mapping each record to a standard segment_id based on position, and aggregating the values over predefined time intervals. Server outputs, for each road segment and time interval, aggregated statistics such as average speed, vehicle count, and accident frequency, and stores these results in a traffic_stats table keyed by segment_id and time slot.

### Step 7:

Server calculates risk indices and priority indices for segments.

Server receives, as input, the aggregated statistics from the traffic_stats table and the structural-problem detections from the structural issues table. Server performs data computation by joining these tables based on geographic proximity or segment_id, computing derived metrics such as accident rate per unit of traffic volume, and applying a risk-scoring function that combines structural-issue types and accident density. Server then computes a priority index by further adjusting the risk index using configurable weights or constraints. Server outputs risk_index and priority_index values per segment and stores them in a risk_priority table.

### Step 8:

Terminal captures user expression, voice, and biological reactions in target areas.

Terminal receives, as input, a list of accident-prone segments or locations from the server, each identified by position information. Terminal performs a comparison between current position and target positions, and when the moving body approaches a target location, the terminal activates the imaging device, the audio input device, and the biological sensor. Terminal records facial image sequences, voice signals, and biological-reaction signals for short windows while the user passes through the area. Terminal outputs raw multimodal emotion-related data labeled with timestamps and positions into local buffers.

### Step 9:

Terminal extracts emotion-related feature vectors.

Terminal receives, as input, the raw multimodal data from the local buffers. Terminal performs data processing by detecting and tracking facial landmarks in each frame, computing expression metrics (such as eye-opening level and mouth-corner movement), and extracting prosodic and spectral features (such as pitch, energy, and spectral centroid) from audio signals. Terminal optionally calculates heart-rate variability and skin-conductance features from biological signals. Terminal normalizes these feature sets over a time window and concatenates them into a numerical feature vector. Terminal outputs a time-stamped and position-tagged feature vector for each window and transmits the vectors to the server or passes them to a local emotion-analysis component.

### Step 10:

Server estimates user emotional states using a multimodal emotion model.

Server receives, as input, the feature vectors and their associated timestamps and positions from the terminal. Server performs data computation by feeding each vector into a trained multimodal neural network that includes separate sub-networks for visual and audio features and a fusion layer. Server computes, via feedforward passes, a probability distribution over emotion classes, such as calm, slightly anxious, highly anxious, and fearful. Server selects the highest-probability class as the estimated emotional state and records the entire distribution for uncertainty analysis. Server outputs emotion-event information including event_id, emotion_category, emotion_confidence, timestamp, latitude, and longitude, and stores these records in an emotion_events table.

### Step 11:

Server computes emotion-based weighted priorities for structural problems.

Server receives, as input, emotion-event records from the emotion_events table and risk indices from the risk_priority table. Server performs data computation by associating emotion events with the nearest structural issues or segments based on position and timestamp, counting events by emotion category for each structural problem, and assigning weights to categories (for example, assigning a higher weight to fear than to slight anxiety). Server calculates an emotion-based score by applying a weighted sum or other function to the event counts and then combines this score with the risk index to obtain an emotion-based weighted priority. Server outputs updated priority values for each structural problem and segment, and stores them back into the risk_priority table.

### Step 12:

Server constructs structured context and generates a prompt sentence.

Server receives, as input, the structural_issues records, traffic_stats records, and emotion-based weighted priorities from the respective tables for a target intersection or segment group. Server performs data processing by summarizing problem types, describing traffic patterns (such as “high nighttime accident frequency in rainy conditions”), and aggregating emotion information (such as “frequent strong anxiety events”). Server fills these summary values into a textual template to create a coherent natural-language description. Server outputs a prompt sentence for a generative AI model, for example:

“Given the following situation: At intersection A, visibility is poor due to sharp curves and roadside obstacles, lane markings are faded, and users frequently report strong anxiety when passing through. Nighttime accident frequency is high, especially in rainy conditions. Please propose detailed engineering and operational improvement measures to reduce accident risk. Include recommendations on traffic light placement, road geometry modification, lighting upgrades, signage, and lane markings, and explain why each measure is effective.” Step 13:

Server calls the generative AI model with the prompt sentence.

Server receives, as input, the generated prompt sentence and configuration parameters such as maximum output length and sampling controls. Server performs data processing by encapsulating the prompt and parameters into a request message and sending the message to an external or internal generative AI model endpoint via a network protocol. Server waits for the model to process the prompt, and then the server receives, as output, a generated text response containing one or more improvement proposals and explanations in natural language.

### Step 14:

Server parses and structures the improvement proposals.

Server receives, as input, the natural-language text response from the generative AI model. Server performs data processing by segmenting the text into individual proposals using pattern-based rules or natural-language parsing, identifying phrases that correspond to improvement-target types, countermeasure content, expected effects, and application conditions. Server normalizes the extracted fields into a structured format and assigns unique identifiers to each proposal. Server outputs improvement-plan information records and stores them in an improvement plans table, with fields such as plan_id, target_segment, improvement_target_type, countermeasure_content, expected_effect, and application_condition.

### Step 15:

Server ranks improvement plans using risk and emotion-based priorities.

Server receives, as input, the improvement-plan records from the improvement plans table and the risk_priority values from the risk_priority table. Server performs data computation by assigning each plan a numerical score derived from the associated segment's risk index and emotion-based weighted priority, optionally adjusted by estimated implementation complexity. Server sorts the plans by score in descending order and marks them with priority levels (for example, high, medium, low). Server outputs a ranked list of improvement plans and stores the ranking results back in the improvement plans table.

### Step 16:

Server evaluates candidate routes of a moving body.

Server receives, as input, a representation of the traffic network (nodes and edges), current origin and destination positions, and the risk and priority information for each segment. Server performs data computation by assigning each edge a base travel-cost value and a risk-related cost derived from the associated risk index and prioritized structural problems. Server computes a combined edge cost by weighting travel and risk contributions and uses a route-search algorithm to calculate candidate routes and their total evaluation values. Server outputs a selected operation route that minimizes the combined cost and records the sequence of segments and waypoints as a route object.

### Step 17:

Server generates warning information along the optimized route.

Server receives, as input, the selected operation route and the list of structural issues and improvement priorities for segments along the route. Server performs data processing by identifying segments with risk indices or emotion-based priorities above certain thresholds and mapping each such segment to a predefined or dynamically generated warning phrase. Server composes warning messages that reference upcoming intersections, visibility concerns, or other specific risks. Server outputs a set of warning records, each containing a segment identifier, a trigger condition (such as distance threshold), and warning text.

### Step 18:

Server delivers the optimized route and warning information to the terminal.

Server receives, as input, the route object and the set of warning records. Server performs data processing by packaging the route as a sequence of geographic waypoints and navigation instructions, and embedding references to warnings that are associated with specific waypoints or segments. Server transmits, as output, a route-and-warning package to the terminal via a secure communication channel, thus enabling the terminal to render the navigation and warnings to the user and to a vehicle control system if present.

### Step 19:

Terminal presents the route, warnings, and improvement information to the user.

Terminal receives, as input, the route-and-warning package and, optionally, selected improvement-plan information pertaining to nearby segments. Terminal performs data processing by converting route waypoints into a graphical representation on a map, highlighting high-risk segments with distinct color or icons, and arranging warning messages in a temporal queue based on distance to each trigger point. Terminal outputs, as visual output, the map and descriptive text on the display, and as audio output, spoken warnings and explanations via an audio output device so that the user can perceive both the navigation and risk information in real time.

### Step 20:

User evaluates perceived safety and improvement adequacy.

User receives, as input, the displayed route, warnings, and any explanations relating to improvement proposals. User performs a cognitive assessment of whether the route and proposed or implemented measures feel safe or adequate. User operates the terminal interface by selecting rating options, answering simple questions, or speaking comments. User outputs evaluation information such as ratings (“still feels unsafe”) and feedback information such as free-text comments (“lighting is still insufficient after 9 PM”), which the terminal captures as structured records.

### Step 21:

Terminal transmits user evaluation and feedback to the server.

Terminal receives, as input, the user's evaluation and feedback entries along with contextual data such as current segment, time, and recent emotion classifications. Terminal performs data processing by encoding the feedback into a standardized message format, anonymizing user identity if necessary, and attaching segment identifiers and timestamps. Terminal transmits, as output, the feedback messages to the server via a secure communication protocol.

### Step 22:

Server updates analysis and prompt-generation conditions based on feedback.

Server receives, as input, the feedback messages from the terminal and existing analytic data from the emotion_events, risk_priority, and improvement plans tables. Server performs data processing by aggregating feedback per location and per improvement type, computing statistics such as consistency between predicted risk and reported perception, and detecting persistent dissatisfaction or residual risk. Server adjusts parameters of the emotion-analysis model (such as decision thresholds), modifies weights in the risk-index calculation formulas, and updates rules or templates used to generate prompt sentences (for example, emphasizing underestimated problems in future prompts). Server outputs updated configuration parameters and stores them in configuration tables, ensuring that subsequent emotion estimation, risk computation, and prompt sentence construction operate under the refined conditions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

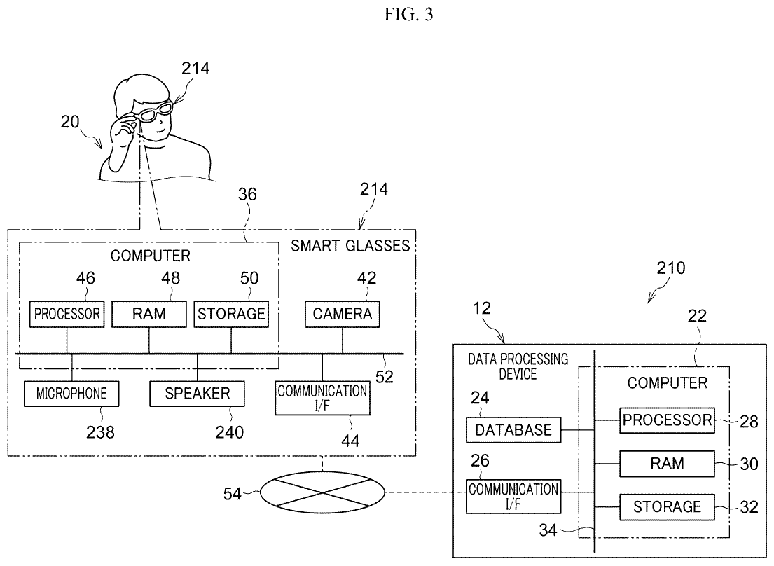

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

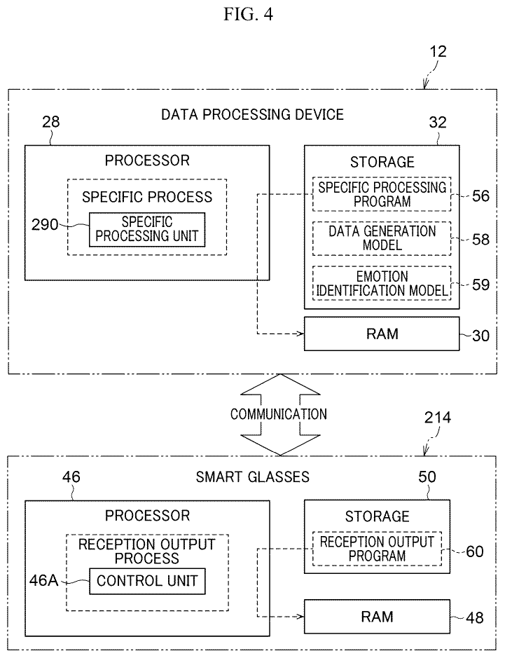

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

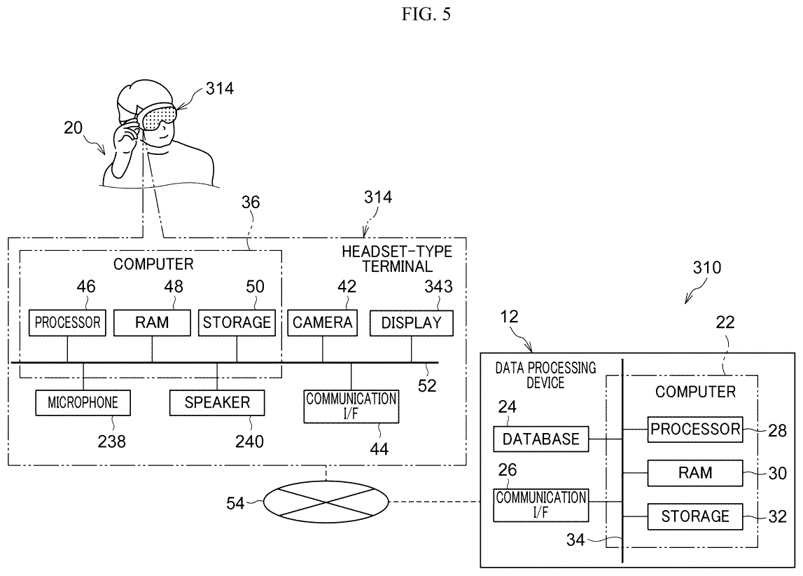

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

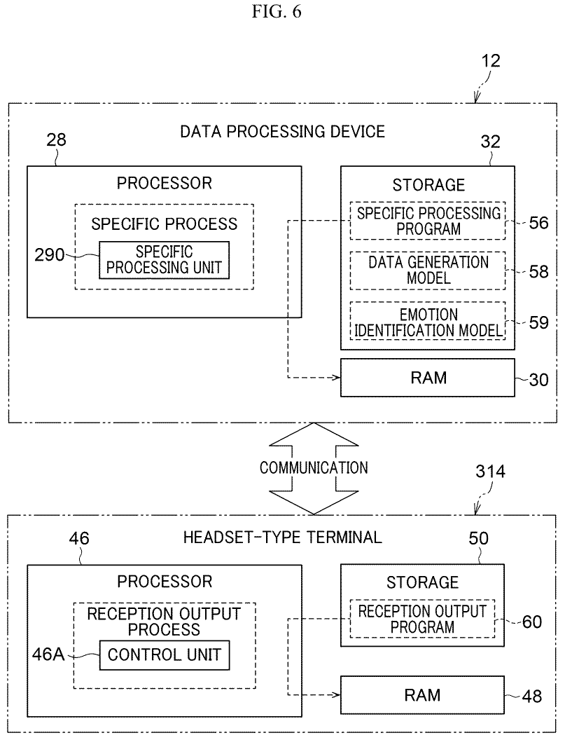

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

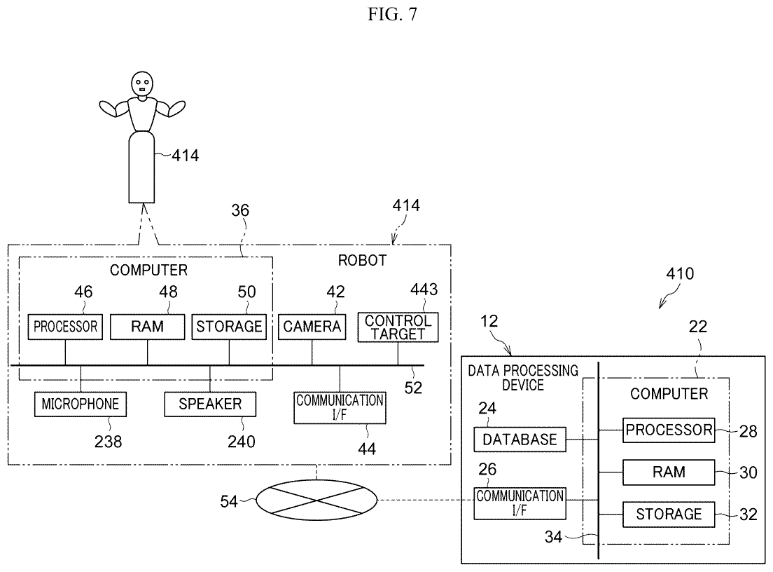

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

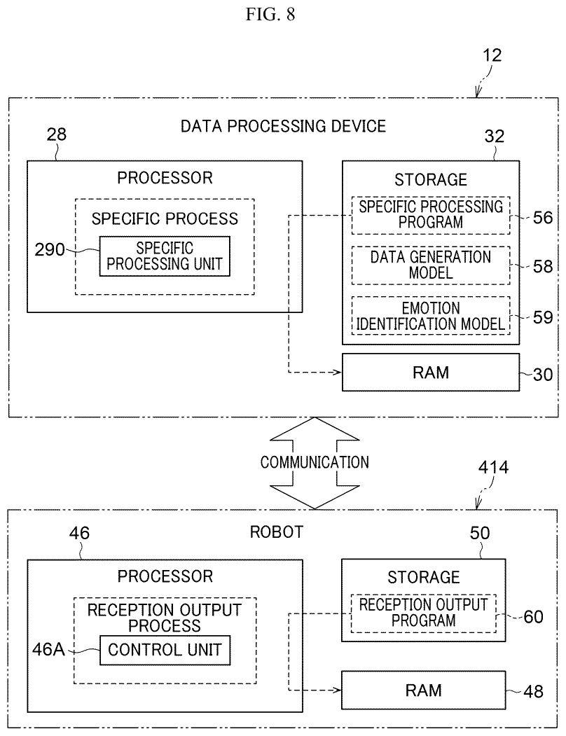

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

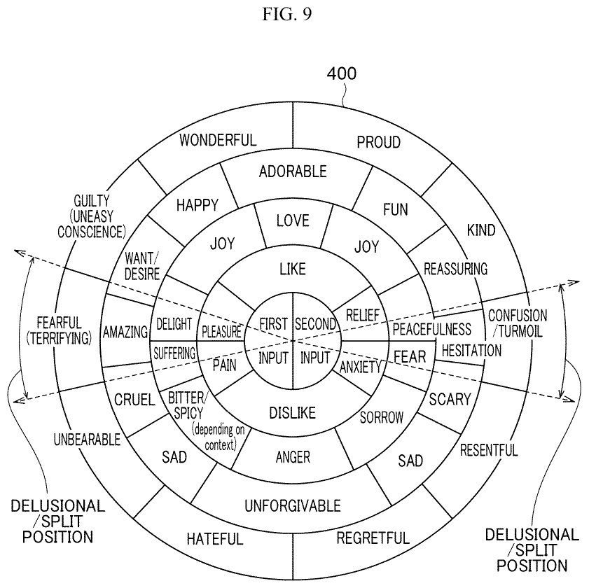

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

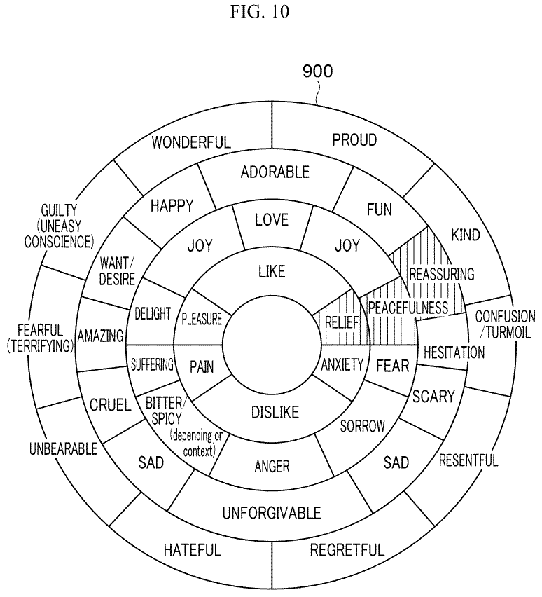

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from an imaging device or a recording device mounted on a mobile body, time-series visual information corresponding to traffic-accident-concentrated regions and non-traffic-accident-concentrated regions, by using wireless communication,
acquire, substantially simultaneously with the visual information, standardized positioning data output from a positioning device, associate the visual information with the positioning data on the basis of time information, and generate position information corresponding to each piece of the visual information,
store the associated visual information and the position information in a storage structure in association with attribute information including an identifier, the time information, and region-type information,
apply an image analysis model to the visual information acquired from the storage structure to extract environmental feature information including road-shape information, traffic-control information, pedestrian-space information, obstacle information, display information, and illumination information, and accumulate feature data in which the environmental feature information is associated with the position information and the region-type information, execute statistical processing or machine learning processing on the feature data to compare the traffic-accident-concentrated regions and the non-traffic-accident-concentrated regions and derive structural problem candidates specific to the traffic-accident-concentrated regions and structural feature candidates contributing to safety,
generate analysis-context information including explanatory-text information and comparison information for each analysis target location or analysis target section, on the basis of the structural problem candidates, the structural feature candidates, the corresponding position information, and the environmental feature information,
generate a prompt sentence by formatting the analysis-context information into a natural-language text and execute a query to a generative AI model by using the prompt sentence as input information, extract, from response information obtained from the generative AI model, explanation information relating to traffic-accident occurrence factors and structural improvement-plan information corresponding to the explanation information, and structure improvement-candidate data by associating the explanation information and the structural improvement-plan information with the position information and the analysis-context information,
perform prioritization processing and category-classification processing on the improvement-candidate data on the basis of at least one of a traffic-safety index, occurrence-frequency information, and user-evaluation information, and generate improvement-plan output information that is placeable on a geographic space on the basis of a result of the processing, and transmit the improvement-plan output information to an external terminal and cause the external terminal to output the improvement-plan output information in a format that is visualizable in association with the position information.

### (Supplementary 2)

The system according to supplementary 1,
wherein the processor is configured to
store the prompt sentence and the response information from the generative AI model in the storage structure as analysis-history information, and execute prompt-generation control processing to update at least one of components, expression format, and explanation level of the prompt sentence on the basis of the analysis-history information and user-evaluation information for the improvement-candidate data.

### (Supplementary 3)

The system according to supplementary 1,
wherein the processor is configured to
perform aggregation processing on a road-section basis or an intersection basis by using geospatial-information processing on the basis of the environmental feature information and the position information acquired from the storage structure, generate, for each unit, a prompt sentence to be input to the generative AI model, and integrate a plurality of generated prompt sentences and corresponding pieces of response information to generate comprehensive improvement-plan output information for a wide-area traffic-accident-concentrated region.

### Application Example 1

### (Supplementary 1)

A system comprising a processor,
wherein the processor is configured to
acquire environmental visual information and positional information related to traffic conditions, associate the acquired visual information and positional information with each other and store the associated information in a storage region,
obtain historical information in which the stored visual information and positional information are associated with past traffic event information,
execute inference processing using a machine learning model to calculate, on the basis of the visual information and the historical information, a numerical index representing a risk level of occurrence of a traffic event,
classify a staged risk level on the basis of the numerical index and a predetermined threshold, generate evaluation result information in which a warning content to be presented to a vehicle operator is structured, on the basis of the classified risk level and environmental attribute information corresponding to the visual information,
generate and transmit a prompt sentence to a generative artificial intelligence model so that the generative artificial intelligence model generates a natural language message including a situation explanation and the warning content, the prompt sentence including the evaluation result information as input information,
acquire the natural language message output from the generative artificial intelligence model and convert the natural language message into output data including at least audio information or visual information, and
present warning information to a user by using the output data.

### (Supplementary 2)

The system according to supplementary 1,
wherein the processor is configured to
generate explanation data including the risk level and justification information based on the numerical index, and input a prompt sentence including the explanation data to the generative artificial intelligence model so as to dynamically generate a guidance message for audio output and a guidance message for visual display in accordance with the risk level.

### (Supplementary 3)

The system according to supplementary 1,
wherein the processor is configured to
employ, as the machine learning model, an image processing model configured to extract feature information from the visual information and a statistical model configured to calculate the numerical index based on the historical information and the positional information, and integrate feature information obtained by the image processing model and feature information obtained by the statistical model to calculate the risk level.

### Example 2

### (Supplementary 1)

A system comprising a processor,
wherein the processor is configured to
acquire image information and video information as environmental information with associated location information, and store the environmental information in a storage medium, and
perform preprocessing on the environmental information by executing pixel value conversion, resolution conversion, reduction of noise components, temporal segmentation, and segmentation into frames as still images, thereby generating preprocessed environmental information, and input the preprocessed environmental information as input data to a machine learning model, and extract structural factors including elements with high probability of accident occurrence, the structural factors comprising at least one of visibility at a traffic junction, distinction between a pedestrian region and a vehicle region, and placement of a signal display device, and aggregate the extracted structural factors in a temporal direction and a spatial direction to generate structured analysis result data including at least one of occurrence frequency, occurrence position, and a severity index, and
mechanically generate a natural language input sentence based on the structured analysis result data, and embed explanation information summarizing the structured analysis result data in the input sentence to construct a generative input sentence, and
input the generative input sentence to a generative artificial intelligence model, and cause the generative artificial intelligence model to generate, in natural language, an improvement description including measures for improving safety of a traffic environment for each of the structural factors, and
associate the improvement description with the structured analysis result data and output them as report information, and
acquire user instruction information for specifying at least one of an expression style of the improvement description and a priority item to be emphasized, and adjust at least one of the generative input sentence and the improvement description in accordance with the user instruction information.

### (Supplementary 2)

The system according to supplementary 1,
wherein the processor is configured to
identify a high-accident region and a non-high-accident region based on location information using a global positioning technique or a geographic information processing technique, and add an identification result to the environmental information, and store the environmental information in association with the storage medium.

### (Supplementary 3)

The system according to supplementary 1,
wherein the processor is configured to
use, as the machine learning model, an image recognition model or a time-series image recognition model including convolution processing, and detect objects including at least one of a vehicle, a pedestrian, a signal display device, a sign, and a crossing region, and relative positional relationships of the objects from the preprocessed environmental information, and extract the elements with the high probability of accident occurrence based on the objects and the relative positional relationships.

### Application Example 2

### (Supplementary 1)

A system comprising a processor,
wherein the processor is configured to
acquire visual information and time-series information corresponding to accident-prone areas and non-accident-prone areas in a traffic region, add position information to the acquired information, and store the position-added information in a storage device,
to perform preprocessing on the stored visual information and time-series information, to extract feature values, and to analyze the preprocessed information by using a machine learning algorithm so as to specify structural problems including at least one of poor visibility at an intersection, unclear traffic-lane separation, inadequate placement of traffic control indicators, and inappropriate control of signaling devices,
to acquire traffic information including at least one of traffic-flow information, traffic-volume information, and accident-history information, and to perform data analysis including statistical processing and clustering processing on the traffic information so as to extract the accident-prone areas, associate the accident-prone areas with the structural problems, and calculate a risk index and a priority index for each area,
to estimate an emotional state of a user by using an emotion analysis engine based on at least one of expression information, voice information, and biological-reaction information of the user, to associate the estimated emotional state with the position information as emotion-event information, and to calculate, based on the emotion-event information and the risk index, an emotion-based weighted priority for each structural problem,
to organize information regarding the structural problems, the traffic information, and the emotion-based weighted priority into a natural-language description or a structured representation, to generate a prompt sentence including the organized information, and to input the prompt sentence into a generative artificial intelligence model so as to obtain, from the generative artificial intelligence model, a response including an improvement proposal for the structural problems,
to analyze the response obtained from the generative artificial intelligence model, to structure the response as improvement-plan information including at least an improvement-target type, countermeasure content, expected effect, and application condition, and to rank the improvement-plan information according to the risk index and the emotion-based weighted priority so as to output an improvement plan having an adjusted priority,
to calculate an evaluation value for a route of a moving body based on the improvement-plan information having the adjusted priority and the risk index, to optimize an operation route of the moving body by using a route-search algorithm, and to output the optimized operation route and warning information along the optimized operation route, and
to acquire evaluation information and feedback information from the user, and, based on the evaluation information and the feedback information, to update analysis conditions of the emotion analysis engine, calculation conditions of the risk index, and generation conditions of the prompt sentence, and to regenerate the prompt sentence for the generative artificial intelligence model based on the updated conditions.

### (Supplementary 2)

The system according to supplementary 1,
wherein the processor is configured to
identify the accident-prone areas and the non-accident-prone areas on the basis of the position information by using at least one of a positioning device and a geographic-information processing device, and to manage a correspondence between the identified areas and at least the structural problems, the emotion-event information, and the improvement-plan information.

### (Supplementary 3)

The system according to supplementary 1,
wherein the processor is configured to
use a machine learning model including an image-recognition algorithm with convolution operations to extract, as the feature values, elements having a high probability of causing accidents from the visual information and the time-series information, and to use the extracted feature values for specifying the structural problems and for generating the prompt sentence.

What is claimed is:

1. A system comprising:
circuitry configured to:
receive, via a communication interface coupled to a packet-switched network, a plurality of image data frames transmitted from a terminal device over the packet-switched network, each image data frame being associated with positioning data;
associate the plurality of image data frames with the positioning data to generate position-tagged data records, and store the position-tagged data records in a storage device in association with region-classification metadata indicating a category of a geographic area corresponding to each image data frame;
apply a trained inference model to the position-tagged data records to extract feature data representing characteristics of environments depicted in the image data frames;
execute comparative analysis processing on the extracted feature data between data records having a first region classification and data records having a second region classification to derive a set of indicator values for each geographic segment;
generate a natural-language prompt sentence based on the indicator values and the feature data, and transmit the natural-language prompt sentence to a generative neural network model to obtain response data comprising generated natural-language output;
parse the response data to extract structured output records, and execute prioritization processing on the structured output records based on at least one of a severity value, a frequency value, and stored feedback data to generate ranked output data; and
transmit the ranked output data to the terminal device via the communication interface.

2. The system according to claim 1, wherein the circuitry is further configured to synchronize the plurality of image data frames with the positioning data based on temporal identifiers by interpolating between positioning data samples acquired before and after a capture time of each image data frame.

3. The system according to claim 2, wherein the trained inference model comprises a convolutional neural network including a plurality of convolutional layers, pooling layers, and detection heads, and the circuitry is configured to apply the convolutional neural network to each image data frame to generate bounding-box coordinates, object-class labels, and confidence scores for detected elements within the image data frame.

4. The system according to claim 3, wherein the feature data comprises environmental feature information including road-shape information, traffic-control information, pedestrian-space information, obstacle information, display information, and illumination information, and the circuitry is configured to aggregate the environmental feature information across a plurality of image data frames corresponding to a common geographic segment to generate segment-level feature records.

5. The system according to claim 4, wherein the circuitry is configured to derive the indicator values by training a gradient-boosting classifier on the segment-level feature records labeled with the region-classification metadata, computing feature-importance scores for each environmental feature, and identifying feature values associated with segments having the first region classification that differ from feature values associated with segments having the second region classification.

6. The system according to claim 1, wherein the circuitry is configured to generate the natural-language prompt sentence by constructing analysis-context data comprising explanatory-text information and comparison information for each geographic segment, and formatting the analysis-context data into the natural-language prompt sentence that includes explicit instructions specifying a desired output format for the generative neural network model.

7. The system according to claim 6, wherein the circuitry is configured to store the natural-language prompt sentence and the response data in the storage device as analysis-history information, and execute prompt-generation control processing to update at least one of components, expression format, and explanation level of subsequent prompt sentences based on the analysis-history information and the stored feedback data.

8. The system according to claim 7, wherein the circuitry is configured to perform aggregation processing on a road-section basis or an intersection basis using geospatial-information processing, generate a respective prompt sentence for each aggregation unit, and integrate a plurality of prompt sentences and corresponding pieces of response data to generate comprehensive ranked output data for a wide-area region encompassing a plurality of geographic segments.

9. The system according to claim 1, wherein the circuitry is further configured to obtain historical event information in which previously stored position-tagged data records are associated with past event records, and calculate a numerical risk index for each geographic segment based on the feature data and the historical event information.

10. The system according to claim 9, wherein the circuitry is configured to classify a staged risk level for each geographic segment by comparing the numerical risk index against a set of predetermined thresholds, generate evaluation result information structured on the basis of the staged risk level and environmental attribute information, and include the evaluation result information in the natural-language prompt sentence to cause the generative neural network model to generate a warning message corresponding to the staged risk level.

11. The system according to claim 10, wherein the circuitry is configured to convert the warning message into output data comprising at least one of audio information and visual information, and transmit the output data to the terminal device for presentation to a user operating a moving body within the geographic segment.

12. The system according to claim 1, wherein the circuitry is further configured to receive, from the terminal device, multimodal user-state data comprising at least one of expression data derived from an imaging sensor, voice data derived from an audio sensor, and physiological data derived from a biometric sensor, and estimate an emotional state of a user based on the multimodal user-state data using an emotion identification model that maps input feature vectors to emotion values on an emotion map having a valence dimension and an arousal dimension.

13. The system according to claim 12, wherein the circuitry is configured to associate the estimated emotional state with corresponding positioning data as emotion-event information, calculate an emotion-based weighted priority for each geographic segment by combining the emotion-event information with the indicator values, and adjust the prioritization processing of the structured output records based on the emotion-based weighted priority.

14. The system according to claim 1, wherein the circuitry is further configured to perform preprocessing on the image data frames by executing at least pixel value conversion, resolution conversion, noise reduction, temporal segmentation, and segmentation into individual frames, thereby generating preprocessed image data, and apply the trained inference model to the preprocessed image data.

15. The system according to claim 14, wherein the circuitry is configured to acquire user instruction information from the terminal device specifying at least one of an expression style of the generated natural-language output and a priority item to be emphasized, and adjust at least one of the natural-language prompt sentence and the structured output records in accordance with the user instruction information.

16. The system according to claim 1, wherein the terminal device comprises one of a smart device, smart glasses, a headset-type terminal, or a robot, and the circuitry is configured to transmit the ranked output data in a format adapted to an output modality of the terminal device.

17. The system according to claim 16, wherein the circuitry is further configured to calculate an evaluation value for a candidate route of a moving body based on the ranked output data and a risk index associated with each geographic segment along the candidate route, execute a route-search algorithm to optimize an operation route of the moving body by minimizing a combined cost function comprising a travel cost and a risk-related cost, and transmit the optimized operation route and associated warning information to the terminal device.

18. A system comprising:
circuitry configured to:
receive, via a communication interface coupled to a packet-switched network, a plurality of time-series image data frames captured by an imaging sensor mounted on a moving body and transmitted from a terminal device, and acquire positioning coordinates from a positioning module substantially simultaneously with the image data frames, synchronize the image data frames with the positioning coordinates based on temporal identifiers, and store position-tagged visual data records in a storage device in association with region-classification metadata;
apply a convolutional neural network model comprising a plurality of convolutional layers, normalization layers, and detection heads to the position-tagged visual data records to extract multidimensional feature tensors representing environmental characteristics including road-shape information, traffic-control information, pedestrian-space information, obstacle information, and illumination information;
execute inference processing using a trained machine learning model on the multidimensional feature tensors to perform comparative analysis between data records classified as a first region type and data records classified as a second region type, and derive structural anomaly candidates and structural safety-contributing candidates for each geographic segment;
generate analysis-context data structures comprising explanatory-text information and comparison information based on the structural anomaly candidates, the structural safety-contributing candidates, the positioning coordinates, and the multidimensional feature tensors, and construct a natural-language prompt sentence by encoding the analysis-context data structures into a formatted text input for a transformer-based generative neural network model;
transmit the natural-language prompt sentence to the transformer-based generative neural network model, receive response data comprising generated natural-language output, parse the response data to extract explanation information and structured remediation-plan records, and associate each remediation-plan record with corresponding positioning coordinates and analysis-context data structures;
execute prioritization processing and category-classification processing on the remediation-plan records based on a computed severity index, an occurrence-frequency value, and stored user-evaluation feedback data, and generate ranked output data mapped to geographic coordinate positions; and
transmit the ranked output data to the terminal device via the communication interface for rendering in a geospatial visualization format overlaid on a digital map display.

19. The system according to claim 18, wherein the circuitry is further configured to store the natural-language prompt sentence and the response data as analysis-history information, compute acceptance-rate statistics per prompt pattern from the stored user-evaluation feedback data, and execute prompt-generation control processing to update template weights and constraint parameters of subsequent prompt sentences based on the acceptance-rate statistics, thereby refining interaction with the transformer-based generative neural network model across successive analysis iterations.

20. A method performed by circuitry of a server coupled to a packet-switched network via a communication interface, the method comprising:
receiving, via the communication interface, a plurality of image data frames transmitted from a terminal device over the packet-switched network, each image data frame being associated with positioning data;
associating the plurality of image data frames with the positioning data to generate position-tagged data records, and storing the position-tagged data records in a storage device in association with region-classification metadata indicating a category of a geographic area corresponding to each image data frame;
applying a trained inference model to the position-tagged data records to extract feature data representing characteristics of environments depicted in the image data frames;
executing comparative analysis processing on the extracted feature data between data records having a first region classification and data records having a second region classification to derive a set of indicator values for each geographic segment;
generating a natural-language prompt sentence based on the indicator values and the feature data, and transmitting the natural-language prompt sentence to a generative neural network model to obtain response data comprising generated natural-language output;
parsing the response data to extract structured output records, and executing prioritization processing on the structured output records based on at least one of a severity value, a frequency value, and stored feedback data to generate ranked output data; and
transmitting the ranked output data to the terminal device via the communication interface.
